(19) United States
(12) Patent Application Publication
(10) Pub. No.: US 2026/0323235 A1
(43) Pub. Date: Oct. 15, 2026

(54) THRESHOLD FOR ADAPTIVE SWEETSPOT COMPENSATION

(71) Applicant: Bang & Olufsen A/S, Struer (DK)

(72) Inventors: Oliver SCHEUREGGER, Valby (DK); Sergio DE LAS HERAS PÉREZ, København (DK); Martin Bo MØLLER, Struer (DK)

(21) Appl. No.: 19/543,769

(22) Filed: Feb. 18, 2026

(30) Foreign Application Priority Data
Feb. 20, 2025 (EP) 25159236.6

(51) Int. Cl. H04S 7/00; H04S 3/00

(52) U.S. Cl. CPC H04S 7/303; H04S 3/008; H04S 2400/11

(57) ABSTRACT

Aspects provide a method of audio reproduction including obtaining an audio signal. The method includes obtaining, with one or more location sensors, dynamic position information including position data of a listener and of at least a pair of loudspeakers within a local reproduction system. The method includes estimating distances between the listener and each of the pair of loudspeakers. The method includes determining an estimated inter product distance difference (IPDD) of the estimated distances between the listener and each of the pair of loudspeakers. The method includes automatically enabling or disabling an adaptive sweetspot compensation function based on the estimated IPDD and on one or more IPDD thresholds. The method includes rendering the audio signal to the local reproduction system.

### CROSS-REFERENCE TO RELATED APPLICATION

This application claims priority to European Patent Application No. 25159236.6, filed Feb. 20, 2025, which is incorporated by reference herein in its entirety.

### INTRODUCTION

### Field

The present disclosure is related to sound reproduction systems and, more specifically, to reproduction of sound fields using adaptive sweetspot compensation.

### Background

Stereophonic sound, more commonly known as “stereo”, is a method of sound reproduction that uses at least two independent audio channels, through a configuration of at least two loudspeakers (or alternatively, a pair of two-channel headphones), to create a multi-directional and three-dimensional audio perspective that provides an audio experience to the listener that creates the impression of sound heard from various directions, as in natural hearing.

As used herein, an audio channel may refer to an audio channel that carries audio data, without metadata, and is implicitly associated with an assumed loudspeaker position. An audio signal (or audio feed) is audio data, without metadata, and is not associated with any loudspeaker output. The audio data may be associated with an audio source. An audio source is the source of an audio signal (e.g., the output of a microphone). A sound source may refer to the source emitting the sound captured by the audio source.

Surround sound refers to stereo systems using more than two audio channels, more than two loudspeakers, or both, to enrich the depth and fidelity of the sound reproduction. Stereo sound can be captured as live sound (e.g., using an array of microphones), with natural reverberations present, and then reproduced over multiple loudspeakers to recreate, as close as possible, the live sound. Pan stereo refers to a single-channel (mono) sound that is then reproduced over multiple loudspeakers. By varying the relative amplitude of the signal sent to each speaker, an artificial direction (relative to the listener) can be created.

One type of stereo audio is referred to as mid/side (M/S). A bidirectional microphone (e.g., with a figure eight pattern) facing sideways and a cardioid facing the sound source can be used to record mid/side audio. The “left” and “right” audio channels are encoded through a simple matrix: Left=Mid+Side and Right=Mid-Side, where “minus” means adding the side signal with the polarity reversed. The stereo width, and thereby the perceived distance of the sound source, can be manipulated after the recording.

Panning algorithms are capable of redistributing audio signals across a given array of transducers. Panning algorithms are used in both the creation of audio content (e.g., a studio mixing desk will typically have stereo pan-pots to position an audio signal across the left-right dimension), as well as in the rendering of audio (e.g., in consumer loudspeaker setups). Examples of panning algorithms include, but are not limited to, Vector Base Amplitude Panning (VBAP), Ambisonic panning (e.g., Ambisonic Equivalent Panning (AEP)), Distance Base Angular Panning (DBAP), Layer Base Amplitude Panning (LBAP), Dual Band Vector Base Panning (VBP Dual-Band), K-Nearest Neighbor (KNN) panning, Speaker-Placement Correction Amplitude Panning (SPCAP), Continuous Surround Panning (CSP), Angular and PanR panning,

In today's media-driven society, there are increasingly more ways for users to access video and audio, with a plethora of products producing sound in the home, car, or almost any other environment. Portable products producing audio, such as, for example, phones, tablets, laptops, headphones, portable loudspeakers, soundbars, and many other devices, are ubiquitous. These products for producing sounds may include, for example, a large variety of audio such as music, speech, podcasts, sound effects, and audio associated with video content.

Next Generation Audio (NGA) refers to developments in technologies that strive to create audio systems which are immersive, providing a user an enhanced immersive auditory experience; adaptive, capable of adapting to different acoustic environments, different listener/speaker locations, and different listening contexts; and interactive, allowing users to make conscious decisions to interact with the system such that the auditory experience is modified in a way that is intuitive and expected by the user. NGA technologies include, for example, rendering technologies, focused on digital processing of audio signals to improve the auditory experience of the listener; user interaction technologies, focused on mapping user-driven actions to changes in the auditory experience; and experiential technologies, focused on using technology to deliver new auditory experiences.

One NGA technology is Object-Based Audio. An audio object includes an audio signal together with metadata that tells the receiver device how to handle the audio. The metadata may describe the position from which the audio signal should be rendered. For example, in a traditional audio production process, many audio sources (e.g., microphones) are used to capture sound, and the audio sources can then be mixed down to a fewer number of channels which represent the final speaker layout, referred to as “downmixing”. For example, a hundred (100) microphones may be used to capture the sound played by an orchestra and then mixed down to two audio channels—one for “left” and one for “right” (to be reproduced by two loudspeakers in a stereo system). With Object-Based Audio, the audio sources can be grouped, or isolated, into audio signals which, when assigned metadata describing how to render that audio signal over a given reproduction system, constitute separate, logical audio objects. For example, the different audio signals might correspond to different individual voices or instruments, different sound effects (e.g., like a passing vehicle). An audio signal for a group of audio sources can make up a logical entity (e.g., a string section or a drum kit). Each audio signal is distributed as a separate object made of the audio and the metadata containing descriptive data describing the audio signal, such as the audio's spatial position, the audio level, and the like. Sometimes, the metadata can be modified by the end-user, allowing the user to control how that audio signal is reproduced; this is referred to as interactivity.

Another example of NGA technology is Immersive Audio, which augments horizontal surround sound with the vertical dimension (i.e., height). Immersive Audio formats may be encoded as either channel-based systems or soundscene-based systems.

In the case of channel-based systems, a number of audio channels contain the audio signals, where each channel is assigned to a discrete physical loudspeaker in the reproduction setup. This is identical to how “non-immersive” channel-based audio formats (e.g., stereo, 5.1) are represented, the only difference being the number of channels available and the number of physical loudspeakers required to reproduce the sound. Examples include 22.2 and 10.2 systems, as described in the ITU-R BS.2159-9.

Soundscene-based audio formats encode an acoustic sound field which can later be decoded to a specified loudspeaker array and/or headphone format. As used herein, a listener may refer to a single human upon whom a sound field impinges. The listener will form a perception of a sound image when exposed to a sound field. A sound field may refer to a physical measurable quantity which is defined at all locations of space and uniquely determined by the sound pressure and particle velocity at all points in space. The sound image may refer to the listener's perceived impinging directions of individual audio outputs rendered via the loudspeakers of a local reproduction system, and which may include lateral, vertical, and depth perception. A sound scene may refer to a recorded sound field (e.g., via an ambisonics microphone) to be reproduced.

One soundscene-based method is Ambisonics, which encodes a sound field above and below the listener in addition to in the horizontal plane (e.g., front, back, left, and right). Ambisonics can be understood as a three-dimensional extension of mid/side stereo that adds additional channels for height and depth. Ambisonics is a technique for storing and reproducing a sound scene at a particular point with spatial accuracy. The degree of accuracy to which the sound scene can be reproduced depends on multiple factors, such as the number of loudspeakers available at the reproduction stage, how much storage space is available, computing power, download/transmission limits, etc. Ambisonics involves encoding a sound scene to create a set of signals, referred to as audio channels, that depends on the position of the sound, with the audio channels weighted (e.g., with different gains) depending on the position of the sound source. A decoder then decodes the audio channels to reproduce the sound scene. Loudspeaker signals can be derived using a linear combination of the Ambisonic component signals.

As discussed herein, faithful reproduction of channel-based a sound scenes relies on the user having a local reproduction system setup very similar to the setup that is used in the production stage of the audio content. The process of audio reproduction may involve mapping a set of input audio signals with a target spatial position (i.e., audio objects), relative to a reference point, to a set of output audio channels which are to be reproduced by a local reproduction system comprising a number of loudspeakers each at a spatial position. As used herein, the relative positions of the loudspeakers in the local reproduction system and the listener may be referred to as the local positions. A listening position may refer to a position of the listener. Listener-loudspeaker distance may refer to the relative distance between the listener and a respective one of the loudspeakers.

If two loudspeakers are symmetrically arranged in front of a listener, are equidistant to the listening position in a canonical “stereo” configuration, and the two loudspeakers play identical audio signals simultaneously, then the sound image will be perceived at a location in the space between the two loudspeakers. This is known as a phantom center (or phantom image), because the sound image is located at a position where there is no loudspeaker to play it.

As discussed in more detail herein, an audio standard associated with the loudspeakers in the local reproduction system may specify canonical relative positions of the loudspeakers and the listener. The canonical positions may define a listening “sweetspot.” The sweetspot refers to the ideal relative listening position of the listener with respect to the canonical positions of the loudspeakers, where the sound scene may be most accurately reproduced, and represents the area between the loudspeakers where the listener is expected to experience the best possible sound quality. The sweetspot can be further identified as a listening position at which the loudspeakers are arranged symmetrically about the listener's frontal orientation and the inter product distance difference (IPDD)—the difference the two listener-speaker distances—is equal to zero meters. As used herein, the IPDD refers to the difference between two listener-loudspeaker distances. The IPDD may be specified in units of meters. In some aspects, the IPDD is an absolute value, but in all cases it is essential that all loudspeakers in the array are equidistant from the listener.

Where the local positions of the loudspeakers of the local reproduction system match the canonical positions, and when the listener position matches the sweetspot location, the audio can be reproduced by the loudspeakers with a high level of fidelity.

In some cases, however, the loudspeakers are incorrectly placed and/or the listener is not positioned at the sweetspot. In this case, there is an error between the assumed spatial positions of the loudspeakers encoded in the audio and the local positions of the loudspeakers in the local reproduction setup and/or there is an error in the listener-loudspeaker distance(s).

As used herein, incorrect loudspeaker positioning refers to loudspeaker local positioning relative to a listener that generates an inaccurate sound image at the listener's position, resulting in a degraded sound image. In some examples, incorrect loudspeaker positioning may occur when the loudspeakers do not adhere to canonical positions (e.g., such as those specified in ITU-R 775). It is common in domestic setups that the user neglects (intentionally or unintentionally) to correctly calibrate and position the loudspeakers according to the relevant standard. In some aspects, the incorrect loudspeaker positioning is a loudspeaker positioning where the loudspeaker is either closer or farther from a listener than a target (e.g., a configured, specified, or threshold) and results in an IPDD that is not equal to zero. In some aspects, the incorrect loudspeaker positioning is a loudspeaker positioning where the loudspeaker is either closer or farther from a listener than another loudspeaker (e.g., the loudspeakers have different relative IPDDs).

Where the loudspeakers are incorrectly placed and/or where the listener is not located in the correct position (e.g., is not equidistant from the loudspeakers), the listener may not perceive the audio experience as intended, thereby degrading the listening experience.

Accordingly, the inventors have applied themselves to developing techniques and apparatus for improving the user experience where the relative loudspeaker and user positions are incorrect.

### SUMMARY

Particular aspects are set out in the appended independent claims. Various optional embodiments are set out in the dependent claims.

The technology described herein provides a method for a threshold for adaptive loudspeaker and listener positioning compensation.

Aspects provide a method of audio reproduction. The method includes obtaining, with one or more location sensors, dynamic position information. The dynamic position information includes position data of a listener and of a pair of loudspeakers within a local reproduction system. The method includes estimating, using the dynamic position information, distances between the listener and each of the pair of loudspeakers. The method includes determining an estimated inter product distance difference (IPDD) of the estimated distances between the listener and each of the pair of loudspeakers. The method includes automatically enabling or disabling an adaptive sweetspot compensation function based on the estimated IPDD and on one or more IPDD thresholds. The method includes obtaining an audio signal. The method includes rendering the audio signal to the local reproduction system.

Aspects provide a system for audio reproduction. The system includes a local reproduction system including at least a pair of loudspeakers. The system includes one or more location sensors configured to collect raw position data. The raw position data includes position data of a listener and of the pair of loudspeakers. The one or more processors are configured to determine dynamic position information from the raw position data. The one or more processors are configured to estimate, using the dynamic position information, distances between the listener and each of the pair of loudspeakers. The one or more processors are configured to determine an estimated inter product distance difference (IPDD) of the estimated distances between the listener and each of the pair of loudspeakers. The one or more processors are configured to automatically enable or disable an adaptive sweetspot compensation function based on the estimated IPDD and on one or more IPDD thresholds. The one or more processors are configured to obtain an audio signal. The system includes a renderer configured to render the audio signal to the local reproduction system.

Aspects provide a computer readable medium comprising (e.g. storing and/or conveying) computer executable code for audio reproduction. The computer executable code includes code for obtaining, with one or more location sensors, dynamic position information, wherein the dynamic position information includes position data of a listener and of at least a pair of loudspeakers within a local reproduction system. The computer executable code includes code for estimating, using the dynamic position information, distances between the listener and each of the pair of loudspeakers. The computer executable code includes code for determining an estimated inter product distance difference (IPDD) of the estimated distances between the listener and each of the pair of loudspeakers. The computer executable code includes code for automatically enabling or disabling an adaptive sweetspot compensation function based on the estimated IPDD and on one or more IPDD thresholds. The computer executable code includes code for obtaining an audio signal. The computer executable code includes code for rendering the audio signal to the local reproduction system.

Aspects provide a loudspeaker. The loudspeaker includes memory. The loudspeakers include one or more processors. The one or more processors are configured to obtain dynamic position information, wherein the dynamic position information includes position data of a listener and of at least a pair of loudspeakers. The one or more processors are configured to estimate, using the dynamic position information, distances between the listener and each of the pair of loudspeakers. The one or more processors are configured to determine an estimated inter product distance difference (IPDD) of the estimated distances between the listener and each of the pair of loudspeakers. The one or more processors are configured to automatically enable or disable an adaptive sweetspot compensation function based on the estimated IPDD and on one or more IPDD thresholds. The one or more processors are configured to obtain an audio signal. The one or more processors are configured to render the audio signal.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 depicts a diagram of an example multimedia system and a perceived phantom center, according to one or more aspects.

FIG. 2 depicts an example local reproduction setup in the multimedia system of FIG. 1, according to one or more aspects.

FIG. 3 depicts a diagram of a target sound field in a multimedia system with canonical loudspeaker and listener positioning, according to one or more aspects.

FIG. 4 depicts an example of a sound field in the multimedia system of FIG. 3 with incorrect loudspeaker positioning, according to one or more aspects.

FIG. 5 depicts an example of a sound field in the multimedia system of FIG. 3 with incorrect listener positioning, according to one or more aspects.

FIG. 6 depicts an example of adaptive sweetspot compensation in the multimedia system of FIG. 5 with the incorrect listener positioning, according to one or more aspects.

FIG. 7 depicts an example workflow for adaptive sweetspot compensation, according to one or more aspects.

FIG. 8 depicts an example graph of a perceived phantom center shift based on inter channel time difference (ICTD) according to one or more aspects.

FIG. 9 depicts example physical and estimated inter product distance difference (IPDD) for correct and incorrect loudspeaker-listener positions according to one or more aspects.

FIG. 10 depicts an example graph showing example perceptual data of IPDD and ICTD to perceived angle of phantom center according to one or more aspects.

FIG. 11A depicts an example graph showing perceived angle of phantom center shift based on IPDD with estimator error according to one or more aspects.

FIG. 11B depicts an example graph showing perceived angle of phantom center shift based on IPDD with estimator error according to one or more aspects.

FIG. 12 depicts an example graph showing perceived angle of phantom center shift based on IPDD extended to the negative plane according to one or more aspects.

FIG. 13 depicts an example graph showing an example estimator error distribution according to one or more aspects.

FIG. 14 depicts the example graph showing perceived angle of phantom center shift based on IPDD extended to the negative plane of FIG. 12 fit to a curve according to one or more aspects.

FIG. 15 depicts an error associated with bypassing adaptive sweetspot compensation and an error associated with adaptive sweetspot compensation for different IPDD values according to one or more aspects,

FIG. 16 depicts an example flow diagram for enabling or disabling adaptive sweetspot compensation, according to one or more aspects.

FIG. 17 depicts an example device for enabling or disabling adaptive sweetspot compensation according to one or more aspects.

### DETAILED DESCRIPTION

The present disclosure provides an approach for a threshold for adaptive sweetspot compensation.

In some aspects, positional data of one or more loudspeakers within a local reproduction setup, positional data of a listener, or both, are dynamically collected. Some examples of sensor technologies used for collection of dynamic positional data includes ultra wideband (UWB), Bluetooth, and ultrasound. In some examples, real-time positional data is collected (e.g., continuously, periodically, responsive to a trigger, or on-demand). In some aspects, a time constant is applied to the collected raw loudspeaker and/or listener positioning data to smooth the raw data. In some aspects, the raw positioning data is positioning data of the loudspeakers relative to a reference point, relative to another loudspeaker, or relative to the listener. In some aspects, the raw positioning data is positioning data of the listener relative to a reference point or relative to one or more loudspeakers. In some aspects, the listener and/or loudspeaker positions are dynamically determined as Cartesian coordinates (e.g., x- and y-coordinates or x-, y-, and z-coordinates) or as spherical coordinates (e.g., Azimuth (degrees), Elevation (degrees) and Distance (meters)).

In some aspects, the positional data is used to adaptively correct the sound field generated by the one or more loudspeakers to compensate for incorrect loudspeaker and/or listener positioning. As discussed herein, however, in some cases, error in the technology used to estimate loudspeaker-listener distances (e.g., the IPDD) will lead to applying an incorrect compensation by the adaptive sweetspot compensation method due to error in the estimated loudspeaker-listener distances. The impact of the error may, or may not, be perceptible by the listener: this depends on a number of factors such as the audio signal being rendered by the loudspeakers and the magnitude of the error of the IPDD estimate.

Accordingly, aspects of the present disclosure provide techniques, apparatus, and systems for a threshold for adaptive sweetspot compensation.

Certain aspects provide for dynamically enabling and disabling of adaptive sweetspot compensation based on the one or more thresholds and based on the estimated loudspeaker-listener distances. Certain aspects provide approaches for determining the one or more thresholds for enabling and disabling the adaptive sweetspot compensation.

Thus, aspects of the present disclosure may ensure that adaptive sweetspot compensation is enabled when it will improve the listener experience and is disabled when it will degrade the listener experience. In addition, because the techniques may be automated, reduced user input is required, which may further improve the user experience.

### Example Audio Reproduction System

In some cases, a user consumes both audio content and associated visual content. Audio content or audio-visual content may be provided by a multimedia system. While aspects of the disclosure are described with respect to a multimedia system, it should be understood that the aspects described herein equally apply to any local reproduction setup.

A multimedia system generally includes a visual display and acoustic transducers. Multimedia installations typically include a display screen, loudspeakers, and a control unit for providing input to the display screen and to the loudspeakers. The input may be a signal from a television provider, a radio provider, a gaming console, various Internet streaming platforms, and the like. It should be understood that other components may also be included in a multimedia installation.

Both audio and visual systems have the option to be tethered, or not, to the user. As used herein, “tethered” refers to whether the audio-visual content moves relative to the user when the user moves. For example, headphones worn by a user which do not apply dynamic head-tracking processing provide a “tethered” audio system, where the audio does not change relative to the user. As the user moves about, the user continues to experience the audio in the same way. On the other hand, loudspeakers placed in a room may be “untethered” and do not move with the user. Similarly, a pair of headphones which employ dynamic head-tracked binaural rendering would be considered a form of “untethered”, albeit one that is simulated. Thus, as the user moves about, the user may experience the audio content differently. Similarly, a television mounted to a wall is an example of an untethered visual system, whereas a screen (e.g., a tablet or phone) held by the user is an example of a tethered visual system. A virtual reality (VR) headset may provide a form of simulated “untethered” video content, in which the user experiences the video content differently as the user moves about. It should be understood that these examples are merely illustrative, and other devices may provide tethered and untethered audio and visual content to a user.

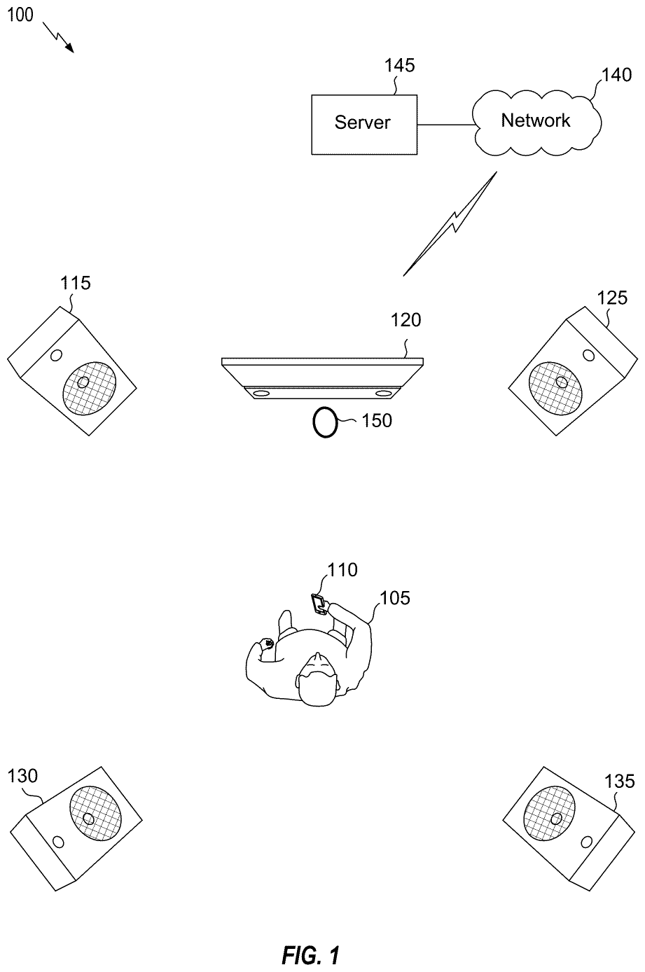

FIG. 1 depicts example multimedia system 100 in which aspects of the present disclosure may be implemented. Multimedia system 100 may be located in any environment, such as in a home (e.g., in a living room or home theater), a yard, a theater, in a vehicle, in an indoor or outdoor venue, or any other suitable location.

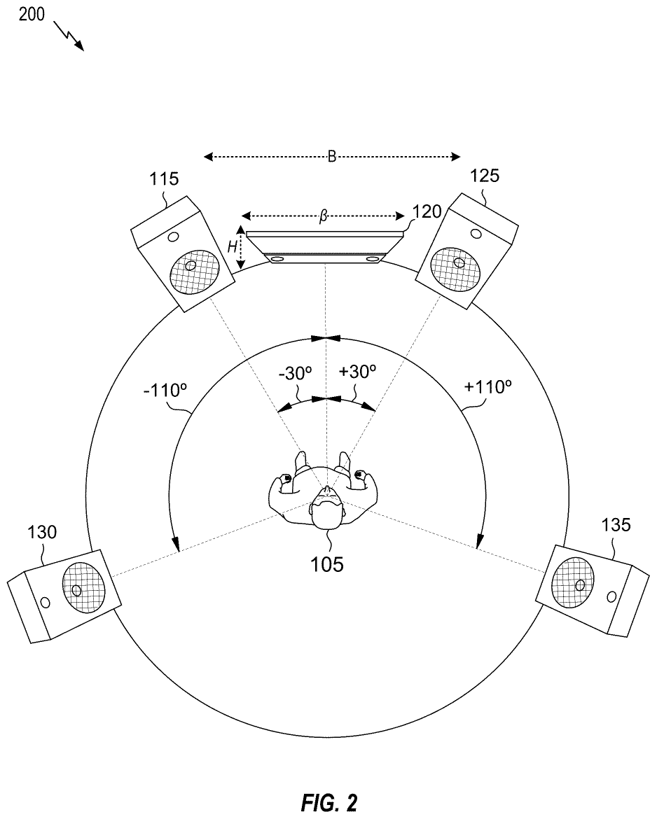

As shown, multimedia system 100 may include loudspeakers 115, 120, 125, 130, and 135. Loudspeakers 115, 120, 125, 130, and 135 may be any electroacoustic transducer device capable of converting an electrical audio signal into a corresponding sound. Loudspeakers 115, 120, 125, 130, and 135 may include one or more speaker drivers, subwoofers drivers, woofer drivers, mid-range drivers, tweeter drivers, coaxial drivers, and amplifiers which may be mounted in a speaker enclosure. Loudspeakers 115, 120, 125, 130, and 135 may be wired or wireless. Loudspeakers 115, 120, 125, 130, and 135 may be installed in fixed positions or moveable. Loudspeakers 115, 120, 125, 130, and 135 may be any type of speakers, such as surround-sound speakers, satellite speakers, tower or floor-standing speakers, bookshelf speakers, sound bars, TV speakers, in-wall speakers, smart speakers, portable speakers. It should be understood that while five loudspeakers are shown in FIG. 1, multimedia system 100 may include fewer or greater number of loudspeakers which may be positioned in multiple different configurations, as discussed in more detail below with respect to FIG. 2.

Multimedia system 100 may include one or more video displays. For example, a video display may be a user device, such as a smartphone or tablet 110 as shown in FIG. 1. It should be understood that a video display may be any type of video display device, such as a TV, a computer monitor, a smart phone, a laptop, a projector, a VR headset, or other video display device.

Although not shown in FIG. 1, multimedia system 100 may include an input controller. The input controller may be configured to receive an audio/visual signal and provide the visual content to a display (e.g., tablet 110 or TV 120) and audio content to the loudspeakers 115, 120, 125, 130, and 135. In some systems, separate input controllers may be used for the visual and for the audio. In some systems, the input controller may be integrated in one or more of the loudspeakers 115, 120, 125, 130, and 135 or integrated in the display device. In some systems, the input controller may be a separate device, such as a set top box (e.g., an audio/video receiver device).

In some aspects, one or more components of the multimedia system 100 may have wired or wireless connections between them. Wireless connections between components of the multimedia system 100 may be provided via a short-range wireless communication technology, such as Bluetooth, WiFi, ZigBee, ultra wideband (UWB), or infrared. Wired connections between components of the multimedia system 100 may be via auxiliary audio cable, universal serial bus (USB), high-definition multimedia interface (HDMI), video graphics array (VGA), or any other suitable wired connection.

In addition, multimedia system 100 may have a wired or wireless connection to an outside network 140, such as a wide area network (WAN). Multimedia system 100 may connect to the Internet via an Ethernet cable, WiFi, cellular, broadband, or other connection to a network. In some aspects, network 140 further connects to a server 145. In some aspects, the input controller may be integrated in the server 145.

Although not shown in FIG. 1, multimedia system 100 may include a renderer. In some aspects, the renderer may be implemented on the input controller. In some aspects, one or more renderers may be implemented in a receiver or decoder (which itself may be implemented in the input controller). The renderer is the component where the audio and its associated metadata are combined to produce the signal that will feed the loudspeakers of the local reproduction setup.

In the case that the local reproduction setup conforms to a canonical standard layout (e.g., as defined in ITU-R 775.3), the renderer may be pre-programmed with the canonical layout. The renderer is able to map the audio signals to the output loudspeaker signals. In the case that an unknown local reproduction setup is used, the render is provided with information about the local reproduction setup, such as (i) the number of loudspeakers and (ii) the positions (e.g., angle and/or distance) of the loudspeakers relative to a reference position.

Although not shown in FIG. 1, multimedia system 100 may include a decoder. In some aspects, the decoder may be implemented with the renderer. In some aspects, the decoder may be implemented on the input controller. The decoder is the component that decodes an audio signal and/or an audio object with its associated metadata.

A listener 105 may interact with the multimedia system 100. For example, the listener 105 may consume audio/visual content output by the multimedia system 100. In the example shown in FIG. 1, the listener 105 may listen to sound from the loudspeakers 115, 120, 125, 130, and 135 and may view video on the tablet 110. In some aspects, the listener 105 may also control the multimedia system 100. For example, the listener 105 may position loudspeakers 115, 120, 125, 130, and 135 and/or the video display(s) within the multimedia system 100, and the listener 105 may configure one or more settings of the multimedia system 100.

The number of loudspeakers (five, in the example illustrated in FIG. 1) and positions of loudspeakers within the multimedia system 100 may be referred to herein as the local reproduction setup. The sound output by the local reproduction setup creates a sound field and the listener 105 perceives a sound image with a perceived phantom center 150. A surround sound system that provides a good user experience offers good imaging all around the listener. The quality of the sound field arriving at the listener's ear may depend on both the original sound scene recording and the local reproduction setup.

Recommended, canonical, loudspeaker positions are provided by the International Telecommunication Union (ITU) Radiocommunication Sector (ITU-R). For example, ITU-R BS.775-3 provides recommendations for Multichannel stereophonic sound systems with and without accompanying picture. In some aspects, a multimedia system 100 may be configured according to the ITU-R recommendations. In some aspects, a multimedia system 100 may not be configured according to the standard ITU-R recommendations, but may be configured at any positions desired by the user (e.g., due to area constraints within a room or environment).

FIG. 2 depicts an example local reproduction setup 200 in the multimedia system 100 of FIG. 1, according to one or more aspects. FIG. 2 illustrates local reproduction setup 200 with the five loudspeakers 115, 120, 125, 130, and 135 of example multimedia system 100, however, as discussed herein, different numbers of loudspeakers may be included in the multimedia system with different arrangements.

As shown, the example local reproduction setup 200 includes three front loudspeakers, 115, 120, and 125, combined with two rear/side loudspeakers 130 and 135. Optionally, there may be an even number of more than two rear-side loudspeakers which may provide a larger listening area and greater envelopment for the user. For example, a seven loudspeaker setup may provide two additional side loudspeakers in addition to the left-rear loudspeaker 130 and the right-rear loudspeaker 135.

In some aspects, center loudspeaker 120 may be integrated in a TV (e.g., a high-definition TV (HDTV)) or a soundbar positioned in-front of or below the TV. The left-front loudspeaker 115 and the right-front loudspeaker 125 are placed at extremities of an arc subtending 60° at the reference listening point. As shown in FIG. 2, the left-front loudspeaker 115 is positioned at −30°, where 0° is defined here as the line from the listener 105 to the center loudspeaker 120, and where the minus angle is defined in the left, or counter-clockwise, direction from the center line. As shown in FIG. 2, the right-front loudspeaker 125 is positioned at +30° from the center line, and where the positive angle is defined in the right, or clockwise, direction from the center line. The distance between the left-front loudspeaker 115 and the right-front loudspeaker 125 is referred to as the loudspeaker basewidth (B). Where the center loudspeaker 120 is integrated in a screen, the distance between the reference listening point (e.g., listener 105) and the screen is referred to as the reference distance and may depend on the height (H) and width (β) of the screen. In some aspects, the center and front loudspeakers, 115, 120, and 125 may be positioned at a height approximately equal to a sitting user (e.g., 1.2 meters).

As shown in FIG. 2, the left-rear loudspeaker 130 is positioned between −100° and −120°, e.g., at −110° as shown, and the right-rear loudspeaker 135 is positioned at between +100° and +120°, e.g., +110° from the center line. In some aspects, the side/rear loudspeakers 130 and 135 may be positioned at a height equal or higher than the front loudspeakers and may have an inclination pointing downward. The side/rear loudspeakers 130 and 135 may be positioned no closer to the reference point than the front/center loudspeakers 115, 120, and 125.

In some aspects, for the example local reproduction setup 200, five audio channels may be used for front left (L), front right (R), center (C), left side/rear (LS), and right side/rear (RS). Additionally, a low frequency effects (LFE) channel may be included. The LFE channels may carry low frequency sound effects, this channel is indicated by the “0.1” in a “5.1” surround sound format.

Down-mixing (also referred to as downward mixing or downward conversion) or up-mixing (also referred to as upward conversion or upward mixing) can be performed to reduce or increase the number of channels to a desired number based on the number of delivered signals/channels and the number of available reproduction devices. Down-mixing involves mixing a higher number of signals/channels to a lower format with fewer channels, for example, for a local reproduction setup that does not have enough available loudspeakers to support the higher number of signals/channels. Up-mixing may be used when the local reproduction setup has a greater number of available loudspeakers supporting a higher number of signals/channels than the input number of signals/channels. Up-mixing involves generation of the “missing” channels. ITU-R provides example down-mixing equations and example up-mixing equations.

As mentioned above, while local reproduction setup 200 and multimedia system 100 depict five loudspeakers in an example arrangement, a local reproduction setup may include different numbers of loudspeakers in different arrangements. For example, ITU-R provides recommendations for multimedia systems with three, four, five, and seven loudspeakers for mono-channel systems, mono plus mono surround channel systems, two-channel stereo systems, two-channel stereo plus one surround channel systems, three-channel stereo systems, three-channel stereo plus one surround channels systems, and three-channel stereo plus two surround channels systems. Furthermore, as mentioned above, it should be understood that the local reproduction setup of a multimedia system may be configured in a non-standardized loudspeaker arrangement (e.g., configured with any arbitrary arrangement of two or more loudspeakers). In this case, information about the local reproduction setup (e.g., such as, number of loudspeakers, positions of loudspeakers relative to a reference point, etc.) is provided to the system.

With channel-based audio, the channels can be mixed according to a pre-established speaker layout (e.g., stereo, 5.1 surround, or any of the other systems discussed above) and are then distributed (e.g., streamed, stored in a file or DVD, etc.). In a studio, the recorded sounds pass through a panner that controls how much sound should be placed on each output channel. For example, for a 5.1 surround mix and a sound located somewhere between center and right, the panner will place a portion of the signal on the center and right channels, but not on the remaining channels. The outputs of the panners are mixed (e.g., using a bus) before distribution. That is, the left output of all panners is mixed and placed on the left channel, same for the right channel, and so on. During reproduction, each audio channel is sent to the loudspeaker corresponding to the audio signal. For example, the mixed audio signal for (L) is provided to the left-front loudspeaker, the mixed audio signal for (R) is provided to right-front loudspeaker, and so on.

For object-based audio, instead of mixing all sounds in the studio and distributing the final mix, all of the sounds can be independently distributed and then mixed during reproduction. Thus, like for channel-based audio, panners are used during recording to position the sound, but the panning information is not applied to mix the sound at this stage. Instead, metadata on an audio object is used to indicate where the audio signal should be rendered. During reproduction, the panning information is actually applied to the audio signals based on the actual local reproduction setup. The panning information for a particular audio object may not be static but changing in time. The panning information may indicate the position of the audio signal, the size of the sound (e.g., the desired spread or number of loudspeakers for the audio signal), or other information. Each audio signal and its corresponding metadata is referred to as an “object.”

With object-based audio, the listener 105 can make choices about the configuration of the audio, which can be added to the mix, to optimize the user's experience. For example, the listener 105 can select the audio type (mono, stereo, surround, binaural, etc.), adjust particular audio signals (e.g., turn up the sound for dialogue, where dialogue is provided as an independent object), omit certain audio signals (e.g., turn off commentary on a sports game, where the commentary is provided as an independent object), select certain audio signals (e.g., select a language option for dialogue, where different languages for the dialogue are provided as independent objects), or other user preferences.

As mentioned above, the sounds output by the local reproduction setup produces the sound image with a perceived phantom center 150. In a stereophonic sound reproduction setup including a left and a right loudspeaker (e.g., loudspeakers 115 and 125) radiating sound into a listening area in front of the loudspeakers, optimal stereophonic sound reproduction can be obtained in the symmetry plane between the two loudspeakers (as shown in FIG. 1). If substantially identical audio signals are provided to the two loudspeakers, a listener (e.g., listener 105) sitting in front of the loudspeakers in the symmetry plane will perceive the phantom center 150 in the symmetry plane between the two loudspeakers. However, if the listener for instance moves to the right relative to the symmetry plane, the loudspeaker-listener distance between the listener and the right loudspeaker will decrease and the loudspeaker-listener distance between the listener and the left loudspeaker will increase, resulting in that the perceived phantom center 150 will shift in the direction of the right loudspeaker, even though identical signals are still applied to the two loudspeakers. Similarly, if one loudspeaker is incorrectly positioned, or both loudspeakers are incorrectly positioned, such that the loudspeaker-listener distances between the listener and each loudspeaker differ, the IPDD will be incorrect resulting in a degraded sound image. Thus, generally, the perceived phantom center 150 depends directly on the interaural differences (i.e. differences in the signal between the two ears of the listener), whereby interaural differences can be manipulated by either moving the listening position, or the loudspeakers, or both, resulting in non-equidistant listener-loudspeaker positions. This effect is not desirable as it degrades the stereophonic sound image.

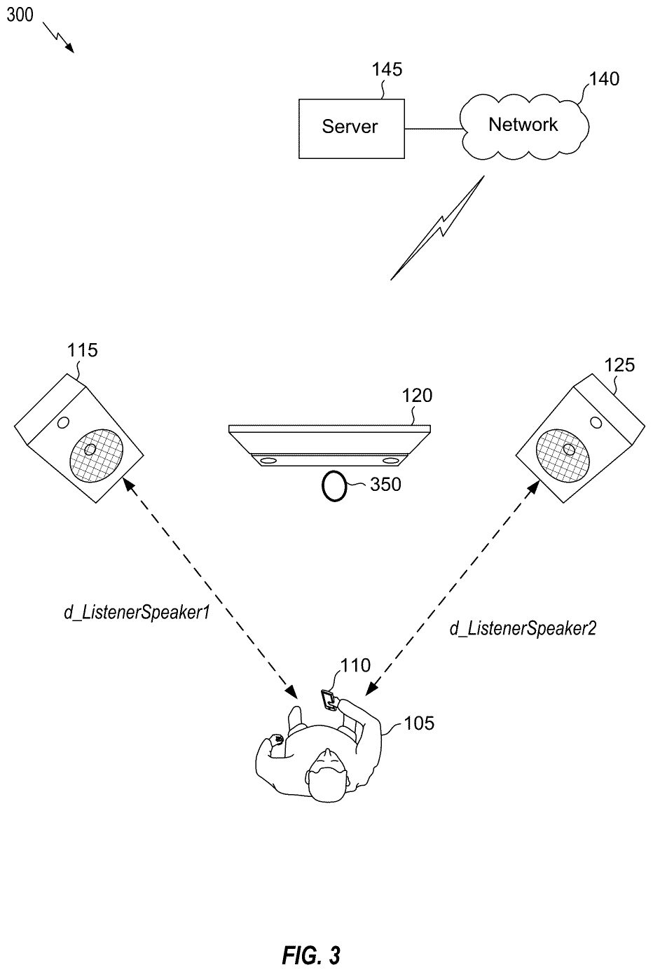

When the loudspeakers are placed with the correct amount of IPDD between the listener and the loudspeakers (i.e., the local position of all loudspeakers match their canonical positions equidistant from the listener and are at the correct apertures relative to the standard, such as ITU 775), a correct sound image is perceived at the listening position, resulting in a user experience that was intended by the producer. FIG. 3 depicts a diagram of a perceived phantom center 350 in a multimedia system 300 with canonical positioning of the listener 105 and the loudspeakers 115 and 125, according to one or more aspects. In this configuration, the loudspeakers are arranged canonically, with the listening position at the sweet spot, the both loudspeakers arranged symmetrically about the listener's forward-facing orientation, and the IPDD is equal to zero meters. The resulting perceived phantom center is localized at the midpoint between the two loudspeakers 115 and 125. As shown in FIG. 3, the loudspeakers 115 and 125 have a correct (or target) IPDD of 0 meters, where the loudspeaker-listener distance of the listener 105 from the loudspeaker 115, d_{ListenerSpeaker1}, is equal to the loudspeaker-listener distance of the listener 105 from the loudspeaker 125, d_{ListenerSpeaker2}, providing a sound image with the perceived phantom center 350 for the listener 105. It should be understood that the correct loudspeaker-listener distance may vary depending on the local reproduction setup, such as the size of the speakers and the distance of the speakers to a reference point (e.g., the listener 105 position) as well as the room acoustics.

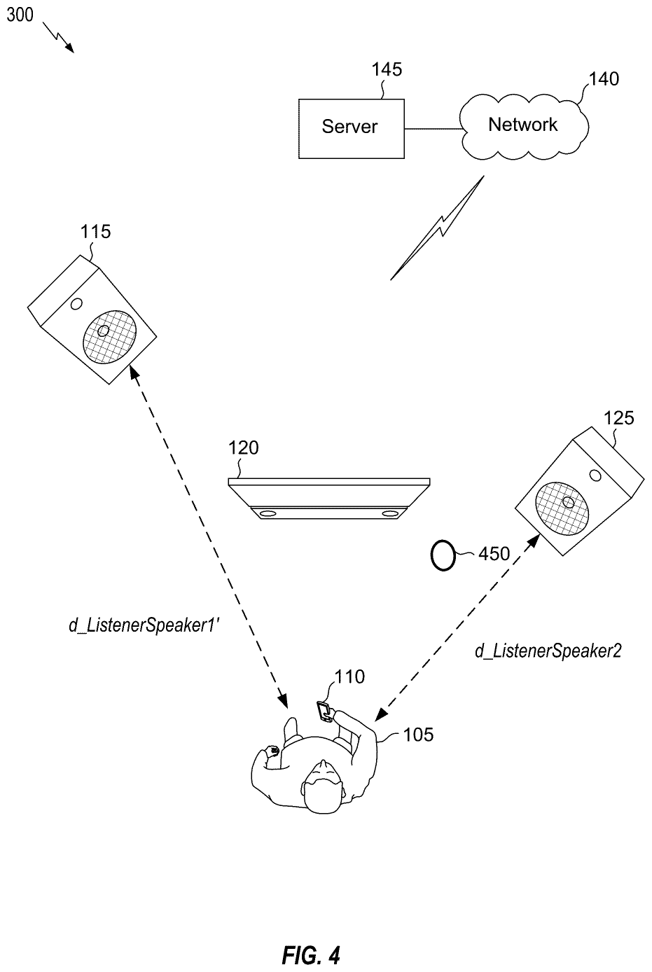

FIG. 4 depicts an example configuration in which the local positions of the loudspeakers 115 and 125 violate the canonical positions. In this configuration, the local positions of the loudspeakers violate the canonical positions, resulting in an IPDD that is not equal to zero meters. The perceived phantom center shifts towards the loudspeaker closest to the listening position. As shown, because the IPDD that is not equal to zero meters, the perceived location of the phantom center 450 shifts towards the loudspeaker 125 that is closest to the listening position. As shown in FIG. 4, the loudspeaker 115 is positioned too far away from the listener 105 with a loudspeaker-listener separation distance, d_{ListenerSpeaker1}′, between the listener 105 and the loudspeaker 115, where d_{ListenerSpeaker1}′>d_{ListenerSpeaker1} and d_{ListenerSpeaker1}′>d_{ListenerSpeaker2}. Accordingly, the perceived phantom center 450 does not match the desired phantom center 350. As shown, the perceived phantom center 450 is shifted, with respect to the phantom center 350, with the front right loudspeaker 125 dominating, providing a poor sound image.

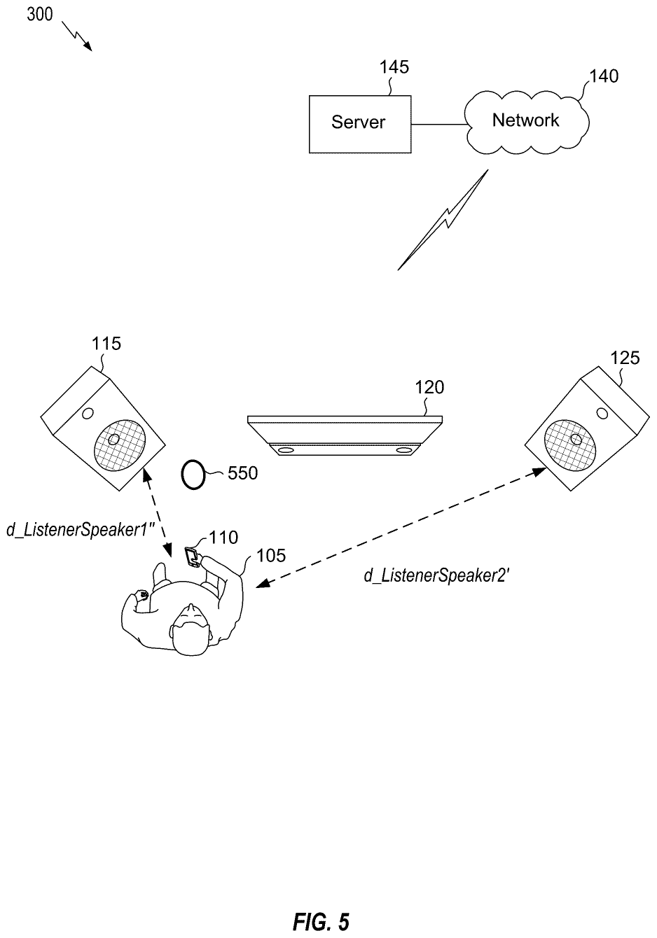

FIG. 5 depicts an example of an incorrectly positioned listener 105 with the loudspeakers 115 and 125 in the multimedia system 300 of FIG. 3, according to one or more aspects. In this configuration, the local positions of the loudspeakers violate the canonical positions, resulting in an asymmetric arrangement of the loudspeakers relative to the listening position and an IPDD that is not equal to zero meters. The perceived phantom center shifts towards the loudspeaker closest to the listening position. As shown in FIG. 5, the listener 105 is positioned too closely to the loudspeaker 115, at d_{ListenerSpeaker1}″, and too far from the loudspeaker 125 at d_{ListenerSpeaker2}′, where d_{ListenerSpeaker1}″<d_{ListenerSpeaker1}, d_{ListenerSpeaker2}′>d_{ListenerSpeaker2}, and d_{ListenerSpeaker1}″<d_{ListenerSpeaker2}′. Accordingly, the listener 105 will not correctly perceive the desired sound image. As shown, the perceived phantom center 550 is shifted, with respect to the phantom center 350, with the front left loudspeaker 115 dominating, providing a poor sound image.

Accordingly, incorrect listener and loudspeaker positioning with an error in the loudspeaker-listener separation distance may cause distortion in the perceived audio by the listener and degrade the user's experience. Consequently, the present teachings include approaches for a loudspeaker setup that does not suffer from this disadvantageous effect of the incorrectly positioned listener and loudspeakers on the perceived sound image.

### Example Adaptive Sweetspot Compensation

Adaptive sweetspot compensation techniques may be used for compensating audio distortion associated with listener position. Adaptive sweetspot compensation may be achieved by applying time delays, and may additionally involve applying gains, to input audio signals to simulate a smaller or larger propagation length (i.e., listener-speaker distance). While examples of adaptive sweetspot compensation techniques are described herein, it should be understood that any adaptive sweetspot compensation technique may be used.

While aspects of the present disclosure are discussed with respect to two loudspeakers, the aspects described herein for adaptive sweetspot compensation may be performed for any pair of speakers in a local reproduction setup including any number of loudspeakers.

In some aspects, a target IPDD between a listener and the loudspeakers is specified. When the collected positional data indicates the estimated IPDD is smaller or larger than the target IPDD, the audio can be adaptively corrected to compensate for the difference between the estimated IPDD and the target IPDD. In some cases, the target IPDD may be defined based on the resolution and/or accuracy of the positioning technology used to detect the listener and/or loudspeaker positions. For example, a low target IPDD may be chosen if the positioning technology is extremely accurate and higher target IPDD may be chosen if the positioning technology is less accurate. In other cases, the target IPDD may be further based on perceptual thresholds at which a typical human may begin to hear degradations in the sound image. In some aspects, the IPDD is measured directly or is computed based on the respective listener positioning data and loudspeaker positioning data.

Adaptively correcting the sound image includes applying one or more corrective time delays to an input audio signal. In some aspects, adaptively correcting the sound image further includes applying one or more corrective gains to the input audio signal. In some aspects, the corrections are applied to the audio signal before rendering the audio signal to a local reproduction system to compensate for the incorrect listener-loudspeaker positioning such that the sound field generated by the loudspeakers results in a perceived phantom center that matches the target phantom center (e.g., the perceived phantom center 350) or the target IPDD. In some aspects, the one or more corrective gains and/or the one or more corrective time delays to apply to the audio signal(s) to compensate for the incorrect IPDD may be determined based on a function, a mapping, or a look-up table that associates different corrective gains and corrective time delays to difference values.

In some aspects, when the listener and loudspeakers are correctly positioned (e.g., as illustrated in the example in FIG. 3), with the target IPDD between them, the adaptive sweetspot compensation can be bypassed, as the user perceives the intended sound image. That is, a linear gain equal to 1.0 and time delay equal to 0 ms or samples (meaning no correction is applied) may be applied to the input audio signals for each of the loudspeakers.

On the other hand, when the listener and/or loudspeakers are incorrectly positioned, with either a negative or positive IPDD, the adaptive sweetspot compensation applies corrective time delays, and in some cases additionally applies corrective gains, to one or more of the audio signals to compensate for the incorrect loudspeaker-listener positioning. According to certain aspects, a panning algorithm is dynamically controlled with dynamic positioning information input to the panning algorithm, where the dynamic positioning information includes spatial positions of the listener and of the loudspeakers of the local reproduction system estimated from positioning data collected by local positioning sensors. The adaptive sweetspot compensation compensates for the incorrect loudspeaker-listening positioning, such that although the listener and loudspeakers are incorrectly positioned, too closely together or too far apart, the adaptively corrected sound field reproduced by the loudspeakers is perceived by the listener 105 with the correct intended sound image and the target perceived phantom center, providing an enhanced listening experience for the user.

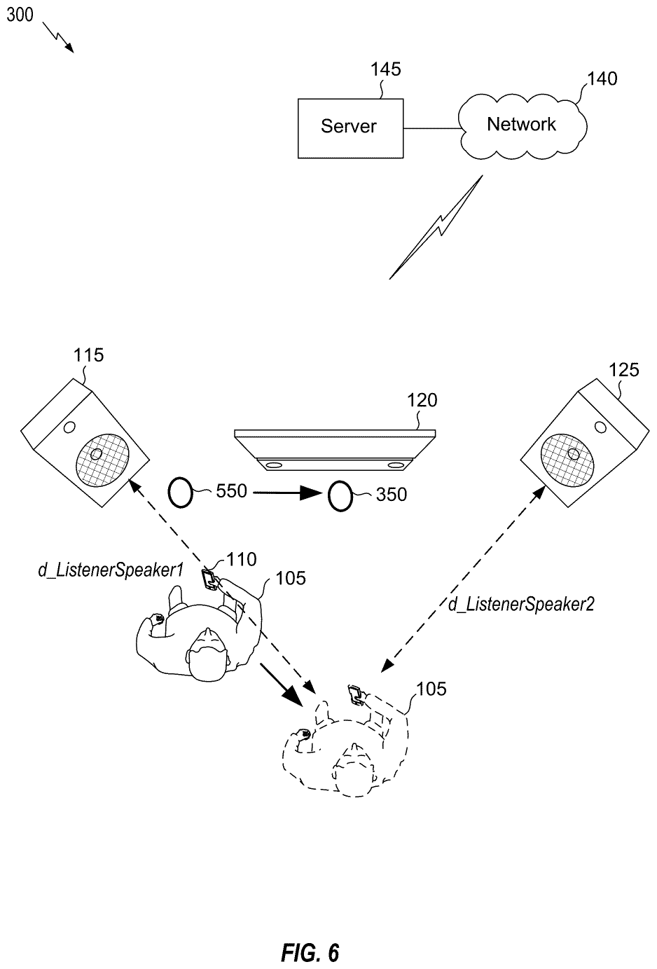

FIG. 6 depicts an example of an adaptively corrected sound field with a shifted perceived phantom center 550 in the multimedia system 300 of FIG. 5 with the listener 105 incorrectly positioned, according to one or more aspects. As shown in FIG. 6, by applying the adaptive sweetspot compensation for the incorrect positioning of the listener 105, the corrected sound field is generated produced such that the listener 105 perceives the desired sound image with the target phantom center 350 as though the listener 105 were correctly positioned. For example, a first corrective gain g₁ and a first corrective time delay t₁ may be applied to the input audio signal for the loudspeaker 115, and a second corrective gain g₂ and a second corrective time delay t₂ may be applied to the input audio signal for the loudspeaker 125. These corrective gains and delays are computed directly from the IPDD. For example, the magnitude and polarity of the differences in distance between d_{ListenerSpeaker1}″and d_{ListenerSpeaker2}′ may be mapped to a corrective time delay and a corrective gain. The first corrective gain g₁ applied to the input audio signal for the loudspeaker 115 is smaller than the second corrective gain g₂ applied to the input audio signal for the loudspeaker 125, while the first corrective time delay t₁ applied to the input audio signal for the loudspeaker 115 is larger than the second corrective time delay t₂ applied to the input audio signal for the loudspeaker 125. In general, a positive time delay is only applied to the loudspeaker positioned closest to the listener, while a time delay of 0 ms or samples is applied to the farther loudspeaker. The gain reduction and added time delay to the input audio signal for the loudspeaker 115 simulates a longer propagation length, effectively placing the loudspeaker-listener local distance at the correct canonical distance (e.g., to effectively change the loudspeaker-listener distance d_{ListenerSpeaker1}″ to d_{ListenerSpeaker1}) as shown in FIG. 6. In addition, the gain and time delay applied to the input audio signal for the loudspeaker 125 effectively places the loudspeaker-listener local distance at the correct canonical distance (e.g., to effectively change the loudspeaker-listener distance d_{ListenerSpeaker2}′ to d_{ListenerSpeaker2}) as shown in FIG. 6.

In some aspects, adaptive sweetspot compensation may be applied to compensate for the incorrect positioning of a loudspeaker 115, for example to correct a scenario illustrated in the example in FIG. 4. For example, the system may apply a negative gain (e.g., to attenuate the audio signal) and a positive time delay to the audio signal sent to the closest loudspeaker 125 to align the time of arrival of the propagated acoustic wave with the farthest loudspeaker 115.

In some aspects, however, when a loudspeaker is positioned “too far” (e.g., farther than a configured, specified, target, or threshold IPDD), a two-phase sound image correction may be performed. The system may determine the IPDD and, where the loudspeakers 115 and 125 are positioned incorrectly (e.g., as determined by the system based on the dynamic positioning information), the system applies a first dynamic gain and time delay to the loudspeaker 125 closest to the listener 105 to generate a corrected sound field. For example, the system applies a first negative gain and a first positive time delay to the loudspeaker 125 to effectively “move back” the loudspeaker 125 to match the listener-loudspeaker distance of the loudspeaker 115 and thus achieve an effective target IPDD. In some aspects, the system applies first dynamic gains and time delays to all loudspeakers to match the listener-loudspeaker distance of the farthest loudspeaker. However, because in this example the loudspeaker 115 is positioned too far from the listener 105, the system then applies a second global gain (e.g., an equal positive gain applied to all loudspeakers within the local reproduction system), to effectively move the loudspeakers 115 and 125 closer to the listener to achieve the correct IPDD.

In some aspects, the two-phase sound image correction may first apply a positive global time delay to all of the loudspeakers in the local reproduction system. The global time delay may be determined based on the listener-loudspeaker IPDD of the nearest loudspeaker to the listener. Then, a negative time delay may be applied to the loudspeakers farther from the listener to effectively move the loudspeakers closer to the listener.

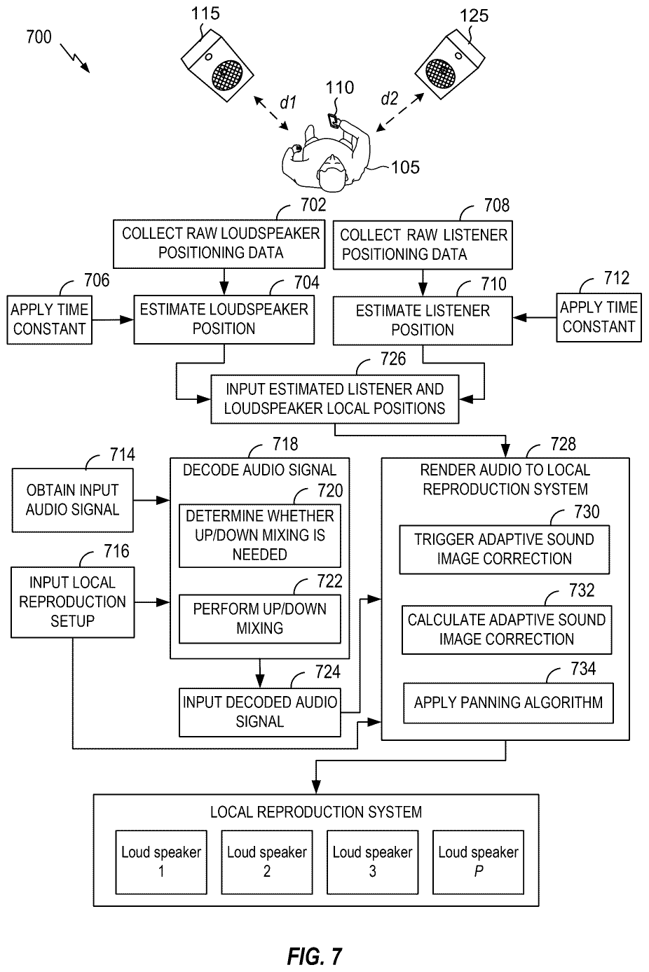

FIG. 7 depicts an example workflow 700 for adaptive sound image correction, according to one or more aspects. As shown in FIG. 7, the listener 105 has a first separation distance, d1, from the loudspeaker 115 and a second separation distance, d2, from the loudspeaker 125. While FIG. 7 is discussed with respect to listener 105 and loudspeakers 115 and 125, it should be understood that the aspects herein may be performed for any number of listeners in a local reproduction system with any number of loudspeakers.

At 702, raw loudspeaker positioning data is dynamically collected. The raw loudspeaker positioning data may include position information of the loudspeakers 115 and 125. In some aspects, the raw dynamic loudspeaker positioning data is collected continuously by one or more local sensors. In some aspects, the raw dynamic loudspeaker positioning data collection is triggered, such as by motion detection.

At 704, loudspeaker spatial local positions are estimated based on the raw dynamic loudspeaker positioning data. In some aspects, the loudspeaker spatial local positions are estimated in real-time (e.g., continuously or whenever the dynamic loudspeaker positioning data is received). In some aspects, the loudspeaker spatial local position estimation is triggered, such as by a motion detection. In some aspects, a time constant is applied, at 706, to smooth the raw sensor data to reduce the sensitivity of the system. For example, the time constant may be used to filter out loudspeaker position data that occurs for a time duration smaller than the time constant threshold.

In some aspects, the loudspeaker position data is processed to produce spatial information, such as Cartesian coordinates (e.g., x- and y-coordinates or x-, y-, and z-coordinates) or spherical coordinates (e.g., Azimuth (in degrees) and distance (in meters) or Azimuth (in degrees), distance (in meters), and elevation (in degrees)) of the loudspeakers. The Cartesian or spherical system may be defined around a reference point, such as a target loudspeaker position, a target listener position, or other reference point. In some aspects, the loudspeaker spatial positions are represented as a P-element array of the Cartesian or spherical coordinates, where P is the number of physical loudspeakers in the local reproduction setup.

In some aspects, the collection of the dynamic raw loudspeaker position data and the processing of the dynamic raw loudspeaker position data, at 702-706, may be performed at a single integrated device or across multiple devices. In some aspects, the device or system that collects and processes the dynamic raw loudspeaker position data is implemented on another device within the system. For example, the dynamic raw loudspeaker position data collection and processing may be implemented on a loudspeaker (e.g., one or multiple of the loudspeakers 115 and 125) within the local reproduction system (e.g., multimedia system 100) or implemented on a control unit within the system. In some aspects, the dynamic raw loudspeaker position data collection and processing may be implemented on a separate stand-alone device within the system. In some aspects, the dynamic raw loudspeaker position data processing could be performed outside of the system, such as by a remote server (e.g., server 145).

At 708, raw listener positioning data is dynamically collected. The raw listener positioning data may include position information of the listener 105. In some aspects, the raw dynamic listener positioning data is collected continuously by one or more local sensors. In some aspects, the raw dynamic listener positioning data collection is triggered, such as by motion detection. In some aspects, the raw dynamic listener positioning data is collected using local sensor technologies such as UWB, Bluetooth, ultrasound, or other positioning technologies.

At 710, listener spatial positions are estimated based on the raw dynamic listener positioning data. In some aspects, the listener spatial position is estimated in real-time (e.g., continuously or whenever the dynamic listener positioning data is received). In some aspects, the listener spatial position estimation is triggered, such as by a motion detection. In some aspects, a time constant is applied, at 712, to smooth the raw sensor data to reduce the sensitivity of the system. For example, the time constant may be used to filter out listener position data that occurs for a time duration smaller than the time constant threshold.

In some aspects, the listener position data is processed to produce spatial information, such as Cartesian coordinates (e.g., x- and y-coordinates or x-, y-, and z-coordinates) or spherical coordinates (e.g., Azimuth (in degrees) and distance (in meters) or Azimuth (in degrees), distance (in meters), and elevation (in degrees)) of the loudspeakers. The Cartesian or spherical system may be defined around a reference point, such as a target loudspeaker position, a target listener position, or other reference point. In some aspects, the listener spatial positions are represented as a 1-element array of the Cartesian or spherical coordinates.

In some aspects, the collection of the dynamic raw listener position data and the processing of the dynamic raw listener position data, at 708-712, may be performed at a single integrated device or across multiple devices. In some aspects, the device or system that collects and processes the dynamic raw listener position data is implemented on another device within the system. For example, the dynamic raw listener position data collection and processing may be implemented on a loudspeaker (e.g., one or multiple of the loudspeakers 115 and 125) within the local reproduction system (e.g., multimedia system 100) or implemented on a control unit within the system. In some aspects, the dynamic raw listener position data collection and processing may be implemented on a separate stand-alone device within the system. In some aspects, the dynamic raw listener position data processing could be performed outside of the system, such as by a remote server (e.g., server 145).

The collection and processing of the raw dynamic loudspeaker positioning data, at 702-706, and the raw dynamic listener positioning data, at 708-712, may be performed at different times or at the same time. The collection and processing of the raw dynamic loudspeaker positioning data, at 702-706, and the raw dynamic listener positioning data, at 708-712, may be performed by the same sensors and devices or by different sensors and devices. In some aspects, raw distance data between the listener and the loudspeakers is dynamically collected and processed.

At 714, the system obtains an input audio signal. The audio signal may be a channel-based audio signal or an object-based audio signal. The input audio signal is associated with target loudspeaker positions for the decoded audio signals. For object-based audio, the target loudspeaker positions are represented as a separate stream of data with time-varying positional data that informs any downstream renderers where each audio stream should be positioned in space. For channel-based audio, the target loudspeakers may be encoded in the audio signal and metadata may be provided by the decoder output or derived from the number of decoded audio channels.

At 716, local reproduction setup information is input to a decoder. The local reproduction setup information may include the number of available loudspeakers in the local reproduction system, positions (e.g., angle and/or distance) of the loudspeakers relative to a reference point, and/or capabilities of the loudspeaker. The capabilities of the loudspeakers may include a frequency response, a minimum output level, a maximum output level, and/or a sensitivity of the loudspeakers.

At 718, the input audio signal is decoded. In some aspects, the input audio signal is decoded based on the local reproduction setup information. For example, the system may determine how many output audio channel to decode. At 720, the system may determine whether upmixing or downmixing is needed based on the number of audio channels and the number of available loudspeakers within the local reproduction system. At 722, the system performs upmixing or downmixing on the audio signal based on the determination at 720. For an N-channel input audio signal, the decoder outputs an M channel audio signal, where M may be equal to (in the case of no upmixing or downmixing), larger than (in the case of upmixing), or smaller than N (in the case of downmixing). Where upmixing or downmixing is performed, the target spatial locations associated with the audio signal may be updated. The decoder may provide metadata with the target spatial locations or the updated target spatial locations with the output audio signal.

In some aspects, the decoding, at 718-722, may be performed at a single integrated device or across multiple devices. In some aspects, the device or system that decodes the input audio signal is implemented on another device within the system. For example, the decoding may be implemented on a loudspeaker (e.g., one or multiple of the loudspeakers 115 and 125) within the local reproduction system (e.g., multimedia system 100) or implemented on a control unit within the system. In some aspects, the decoding may be implemented on a separate stand-alone device within the system. In some aspects, the decoding may be performed outside of the system, such as by a remote server (e.g., server 145).

At 724, the decoded audio signal is input to a local reproduction system renderer. As shown in FIG. 7, the local reproduction setup information, at 716, is also provided to the local reproduction system renderer. In addition, at 726, the estimated listener and loudspeaker positions are input to the local reproduction system renderer. In some aspects, the estimated listener and loudspeaker positions are input to the local reproduction system renderer in real-time (e.g., immediately after being estimated at 704 and 710). In some aspects, the estimated listener and loudspeaker positions are input to the local reproduction system renderer upon a trigger (e.g., when the decoded audio signal is input to the renderer). In this case, the estimated listener and loudspeaker positions may be stored in memory until triggered to input to the local reproduction system renderer.

At 728, the decoded audio signal is rendered to the local reproduction system (e.g., to the loudspeakers 1 . . . P). The local reproduction system renderer renders the audio to the physical loudspeakers in the local reproduction system based on the estimated loudspeaker positions, the estimated listener positions, the target loudspeaker positions, and the local reproduction setup information. For example, at 734, the local reproduction system renderer applies a panning algorithm to map M input audio signals with corresponding target spatial positions to P output audio signals to be reproduced by the P loudspeakers at the estimated spatial positions.

As shown in FIG. 7, the rendering may further include the adaptive sound image correction. At 730, the system may determine whether adaptive sound image correction is needed. For example, the system may determine whether adaptive sound image correction is needed based on the estimated listener and loudspeaker positions. In some aspects, the system determines adaptive sound image correction is not needed where the listener and loudspeakers are correctly positioned and determines the adaptive sound image correction is needed where listener and/or one or more loudspeakers are incorrectly positioned.

At 732, the system calculates the adaptive sound image correction. For example, the system may compute a delay and/or a gain to be applied to any of the P output channels to any of the P loudspeakers. The delay and/or the gain may be computed to correct for the incorrect listener and/or loudspeaker positioning. For example, the delay and/or the gain may be computed to compensate for the IPDD, such that the sound field generated by the P loudspeakers matches, or attempts to match as closely possible, to a target or desired IPDD. The computed gains and/or delays may then be applied to the respective audio signals.

In some aspects, the rendering, at 728-734, may be performed at a single integrated device or across multiple devices. In some aspects, the device or system that renders the decoded audio signal is implemented on another device within the system. For example, the rendering may be implemented on a loudspeaker (e.g., one or multiple of the loudspeakers 115 and 125) within the local reproduction system (e.g., multimedia system 100) or implemented on a control unit within the system. In some aspects, the rendering may be implemented on a separate stand-alone device within the system. In some aspects, the rendering may be performed outside of the system, such as by a remote server (e.g., server 145).

Example Threshold for Adaptive Sweetspot Compensation

As discussed above, the stereophonic sound image is an auditory illusion created when two or more loudspeakers emit sound in which localization cues are encoded through panning techniques, where the standard for stereo audio dictates that each loudspeaker should be placed at ±30° of the listener and at equidistance from the listener. During reproduction of the audio, if these conditions are not satisfied, the auditory illusion at the listening position will degrade, with a worst-case scenario that only the closest loudspeaker contributes to the perceived stereo image.

As discussed above, adaptive sweetspot compensation provides techniques for providing an enhanced experience to a listener, or listeners, to compensate for various loudspeaker-listener misplacements. The adaptive sweetspot compensation involves estimating the distance from a listener to each loudspeaker within a local reproduction setup and estimating the IPDD. The adaptive sweetspot compensation involves applying a corrective time delay, and sometimes a corrective gain, to one or more of the loudspeakers such that the time of arrival and levels of the loudspeakers match at the listener's ears. The time delays and gains may be determined based on the determined IPDDs, where the magnitude indicates how much corrective time delay and/or corrective gain to apply and the polarity (negative or positive) indicates to which loudspeaker the corrective time delay and/or the corrective gain should be applied (left or right).

The estimation of the loudspeaker-listener distances involves error. The amount of error may depend on the particular technology used in the estimation. The error in the estimation leads to an error in the IPDD and, in turn, to error in the adaptive sweetspot compensation (e.g., leading to an over-correction). In some cases, the amount of error introduced by the adaptive sweetspot compensation, due to the error in the distance estimation (referred to herein as the “estimator error”), can be greater than the amount of error due to the incorrect positioning of the listener and/or the loudspeakers (referred to herein as the “ground truth error” or the “physical error”). In this case, the use of the adaptive sweetspot compensation may further degrade the listening experience, rather than improving it.

Referring to the example illustrated in FIG. 3, in which the listener 105 and loudspeakers 115 and 125 are in the correct positions, there is no physical error (i.e., IPDD=0.0 meters) and, therefore, no adaptive sweetspot compensation is needed: a time delay of 0 milliseconds and a linear gain of 1.0 should be applied to both loudspeakers. However, the technology used to estimate the loudspeaker-listener distances introduces some estimator error and will incorrectly inform the adaptive sweetspot compensation system of a non-zero physical error and the adaptive sweetspot compensation system will incorrectly apply a non-zero time delay which may degrade the user listening experience. Whether or not the system error introduces a perceived degradation of the sound image will depend on a number of factors such as the type of audio signal being played and the magnitude of the system's error.

Referring to the example illustrated in FIG. 4 or FIG. 5, in which the listener 105 and loudspeakers 115 and 125 are misplaced, there is physical error. In addition, the estimator technology introduces some estimator error. In this case, two errors are present: the physical error and the estimator error. If the estimator error introduces some error in the adaptive sweetspot compensation and that error is less than the physical error, then the adaptive sweetspot compensation will still improve the listener experience. However, if the estimator error is higher than the physical error, then the error in the time delay and/or the gain computed for the adaptive sweetspot compensation will be higher than the physical error, and subsequently the adaptive sweetspot compensation has made the listening experience worse than the physical error itself.

Accordingly, the present teachings include techniques for dynamically applying adaptive sweetspot compensation in order to avoid adaptive sweetspot compensation that degrades the listening experience.

According to certain aspects, techniques, apparatus, systems, and computer readable mediums are provided herein for adaptive sweetspot compensation using a threshold based on the estimator error relative to the physical error and based on perceptual data.

In some aspects, the threshold is determined based on a distribution of the estimator error and perceptual data. The perceptual data is associated with how a human perceives shifts in the stereo image as a function of inter channel time delay (ICTD). The ICTD is the time delay between two loudspeakers and, therefore, is directly proportional to the IPDD.

In aspects, the threshold is determined based on estimation accuracy statistics. In some aspects, ICTD may be imposed directly by using fixed loudspeaker and listener positions and delaying the signal to one loudspeaker more than the other (e.g., in response to adaptive sweetspot compensation): this corresponds, in effect, to how adaptive sweetspot compensation methods work. In some aspects, ICTD may be imposed indirectly when the distances between each loudspeaker and the listener is not equal: this corresponds, in effect, to what happens when non-canonical loudspeaker positions are employed. For example, the listener may move relative to the loudspeakers resulting in different loudspeaker-listener distances and different ICTDs.

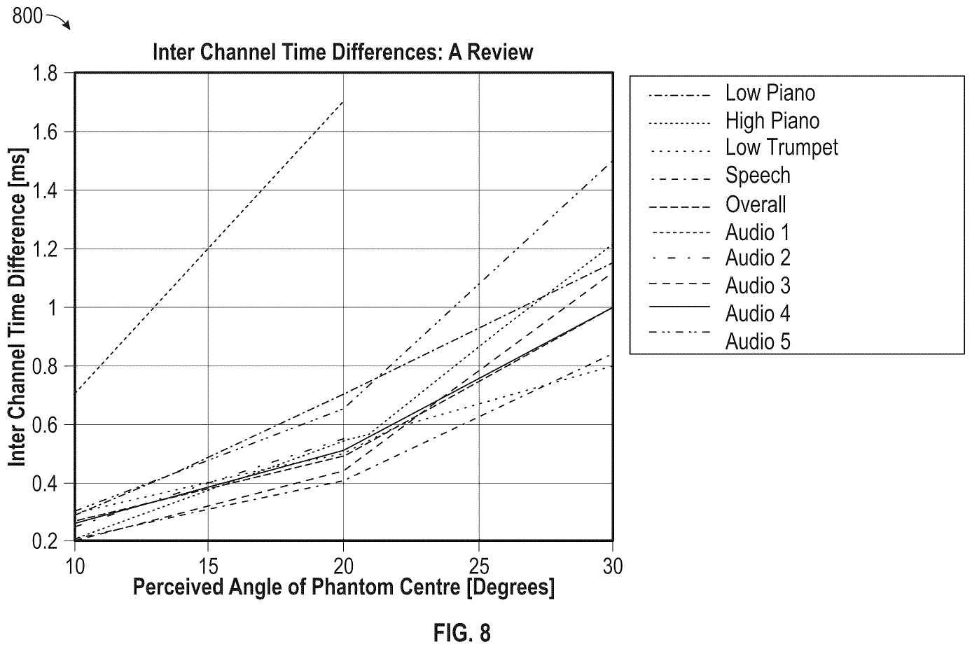

An ICTD greater than 0 milliseconds will result in a perception of the phantom center moving towards the loudspeaker with the least time delay. The exact relationship between ICTD and the perceived phantom center (e.g., in degrees or percentage of the stereo image) will depend on a number of factors including room acoustics, air temperature, loudspeaker directivity and audio signal (e.g., broadband music, single tones, noise, high frequency (HF) or low frequency (LF), and so on). FIG. 8 depicts an example graph 800 of ICTD as a function of perceived phantom center shift in degrees for various audio signals and conditions (room acoustics and stimulus) according to one or more aspects. In all cases, a higher ICTD results in a greater perceived phantom center shift. In an illustrative example, 1.0-1.6 ms of ICTD (corresponding to 34-46.5 cm) may lead to a complete shift of the perceived phantom center (i.e., localized fully in one loudspeaker). In this example, this corresponds to a physical error of 34-46.6 cm (i.e., when one speaker is up to 46.5 cm closer to the listener than the other loudspeaker to the listener), the sound image will be localized fully in the loudspeaker closest to the listener. As physical error decreases, the perceived phantom center moves closer to the midpoint between the loudspeakers. Thus, in this example, an estimator error greater than 46.5 cm would render adaptive sweetspot compensation ineffective as the stereo image is entirely shifted to one loudspeaker. In some aspects, the perceived phantom center shift may be expressed as a percentage rather than a degree. The percentage shift is independent of opening angles in the local reproduction setup.

In some aspects, the threshold is determined based on a smallest perceived error (i.e., perceived phantom center shift) that the adaptive sweetspot compensation can correct for given the estimator error.

In some aspects, when the ICTD is imposed (directly or indirectly), the loudspeaker-listener local distances are Pd_{ListenerSpeaker1} (physical distance between the listener and the first loudspeaker) and Pd_{ListenerSpeaker2} (physical distance between the listener and the second loudspeaker) and the estimated loudspeaker-listener distances are Ed_{ListenerSpeaker1} (the estimator's estimate of the distance between the listener and the first loudspeaker) and Ed_{ListenerSpeaker2} (the estimator's estimate of the distance between the listener and the second loudspeaker).

The IPDD error metrics can be calculated based on the local loudspeaker-listener distances and the estimated loudspeaker-listener distances. The difference between the local loudspeaker-listener distances of the first and second loudspeakers can be calculated as:

IPDD_{PD}=Pd_{ListenerSpeaker1}−Pd_{Listenerspeaker2}=PE (eq. 1)

The difference between the estimated loudspeaker-listener distances of the first and second loudspeakers can be calculated as:

IPDD_{ED}=Ed_{ListenerSpeaker1}−Ed_{Listenerspeaker2} (eq. 2)

In some aspects, the estimator error is determined as the difference between the physical and estimated IPDDs as:

EE=IPDD_{PD}−IPDD_{ED} (eq. 3)

An EE=0 means that the estimator is free of error, whereas a non-zero EE indicates the estimator error.

In some aspects, the system may use the magnitude of the IPDD. In this case, the estimation error may be determined as:

EE=abs(IPDD_{PD})−abs(IPDD_{ED}) (eq. 4)

Taking the absolute value of the IPDDs, a negative estimator error (EE<0) means the estimator estimates the listener to be EE meters from the PE position, in a direction away from the true sweetspot and a positive estimation error (EE>0) means the estimator estimates the listener to be EE meters from the PE position, in a direction towards the true sweetspot.

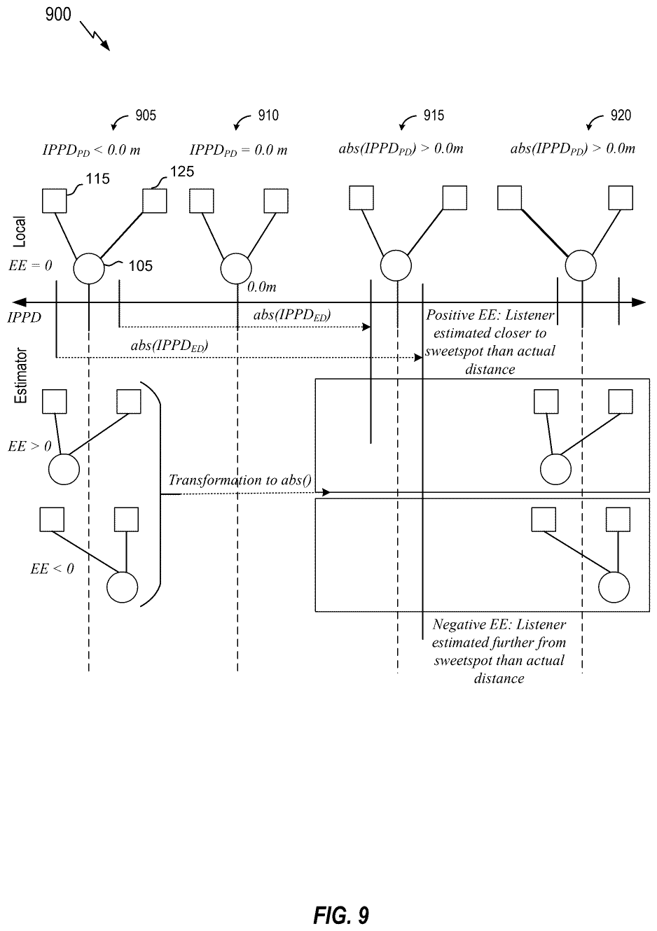

FIG. 9 depicts local and estimated loudspeaker-listening distances for correct and incorrect loudspeaker-listener positioning according to one or more aspects. FIG. 9 shows a setup 905 with the user 105 and loudspeakers 115 and 125 with an incorrect placement where IPDD_{PD}<0.0 m, a setup 910 with a correct canonical placement where IPDD_{PD}=0.0 m, a setup 915 with incorrect placement where abs(IPDD_{PD})>0.0 m, and a setup 920 with incorrect placement where abs(IPDD_{PD})>0.0 m. FIG. 9 shows the setups 905, 910, 915, and 920 with no estimator error (EE=0), with positive estimator error (EE>0), and with negative estimator error (EE<0). As shown in FIG. 9, for the setup 905 with the incorrect placement where IPDD_{PD}<0.0 m, if there is no estimator error (EE=0), the estimated IPPD is equal to the true IPDD. As shown for the setup 905, where there is a positive estimation error, EE>0, the listener is estimated closer to the sweetspot than the actual physical distance of the listener from the sweetspot. As shown for the setup 905, where there is negative estimation error, EE>0, the listener is estimated farther from the sweetspot than the actual physical distance of the listener from the sweetspot.

According to certain aspects, the error of the adaptive sweetspot compensation may be computed.

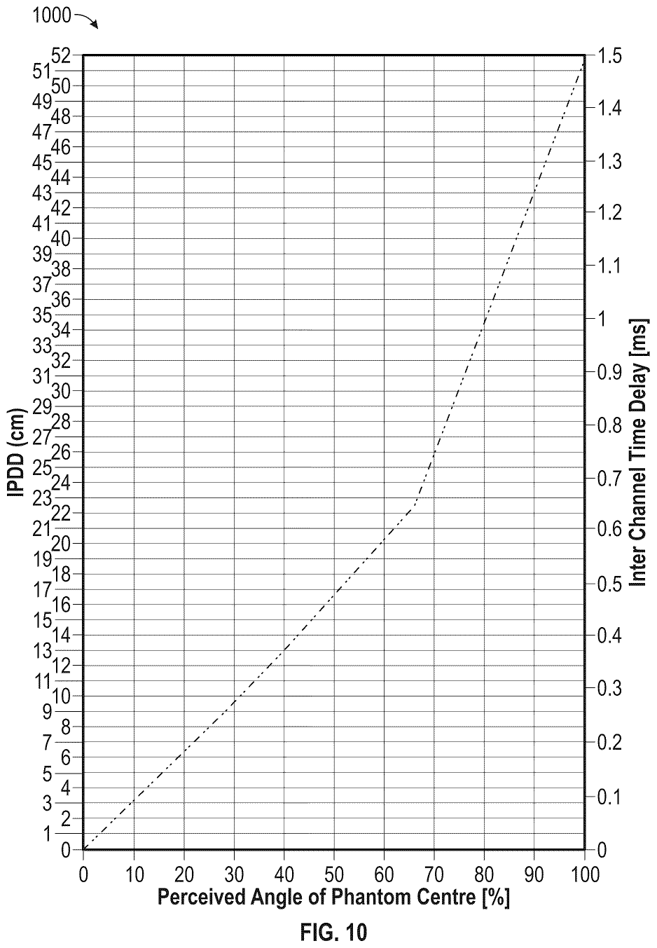

FIG. 10 depicts an example graph 1000 showing example perceptual data of effective IPDD (in centimeters) and corresponding ICTD (in milliseconds) to perceived angle (in percentage shift) of phantom center. Based on the graph 1000, as the listener 105 moves around with respect to the sweetspot, the IPDD changes accordingly and, hence, the perceived phantom center shifts towards the nearest loudspeaker by the corresponding percentage indicated in the graph 1000.

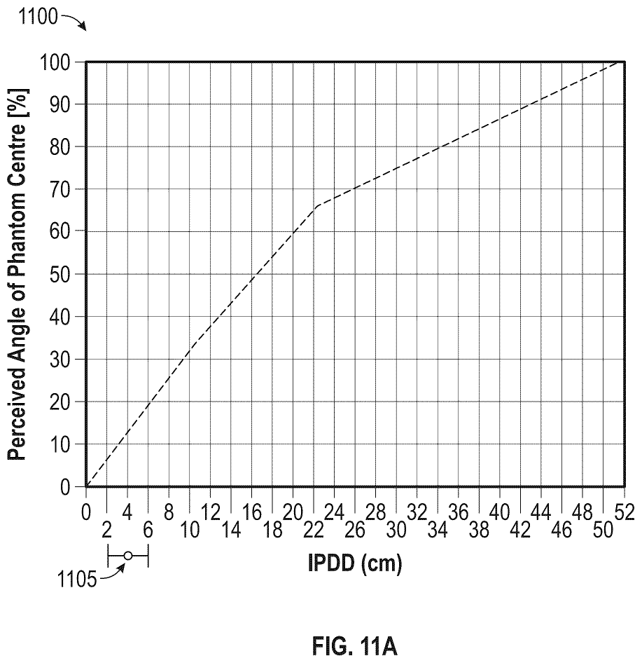

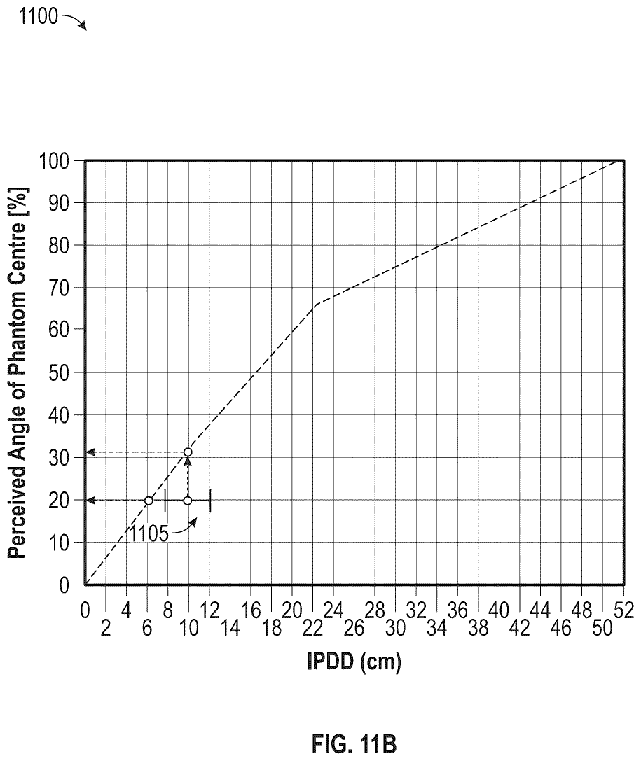

FIG. 11A depicts an example graph 1100 showing perceived angle of phantom center shift based on IPDD with negative estimator error 1105. In the illustrative example, EE=−0.04 m±0.02 m, where the estimator error is on average −4 cm and varies 2 cm above and below that mean value. As can be seen in the FIG. 11B, for an IPDD_{PD}=0.06 m, using the Eq. 4 and the estimator error 1105 (EE=−0.04 m), the IPDD_{ED}=0.10 m. As can be seen in FIG. 11B, for an IPDD_{PD}=0.06 m the perceived angle of phantom center shift (denoted Shift_{PD}) is 20%, whereas with the estimator error the estimated perceived angle of phantom center shift (Shift_{ED}) is 31% for the IPDD_{ED}=0.10 m. The difference of the actual and estimated perceived angle of phantom center shift (Shift_{PD}-Shift_{ED}) represents how much error the adaptive sweetspot compensation system will over-or under-compensate for—in the illustrated example 11%.

The error in the adaptive sweetspot compensation may be determined as a function of the difference in the actual and estimated perceived angle of phantom center shift. For example, the error in the adaptive sweetspot compensation may be determined based on the IPDD_{PD} as:

ε_{AdaptiveSweetspotCompensation}(IPDD_{PD})=y(IPDD_{PD}−EE)−y(IPDDpd) (eq. 5)

, where IPDD_{ED}=IPDD_{PD}−EE, and y is a function (e.g., linear, quadratic, cubic, or other function) that describes the perceptual data. Using the equation for error in the adaptive sweetspot compensation, ε_{AdaptiveSweetspotCompensation} goes to zero (resulting in no error in the sweetspot compensation effecting an image shift that precisely corrects for the physical loudspeaker-listener misplacement) as EE goes to zero (no error in the estimator); ε_{AdaptiveSweetspotCompensation}<0.0 represents an under-compensation (the sweetspot compensation effecting an image shift that is smaller than needed to correct for the physical loudspeaker-listener misplacement); and ε_{AdaptiveSweetspotCompensation}>0.0 represents an over-compensation (the sweetspot compensation effecting an image shift that is larger than needed to correct for the physical loudspeaker-listener misplacement).

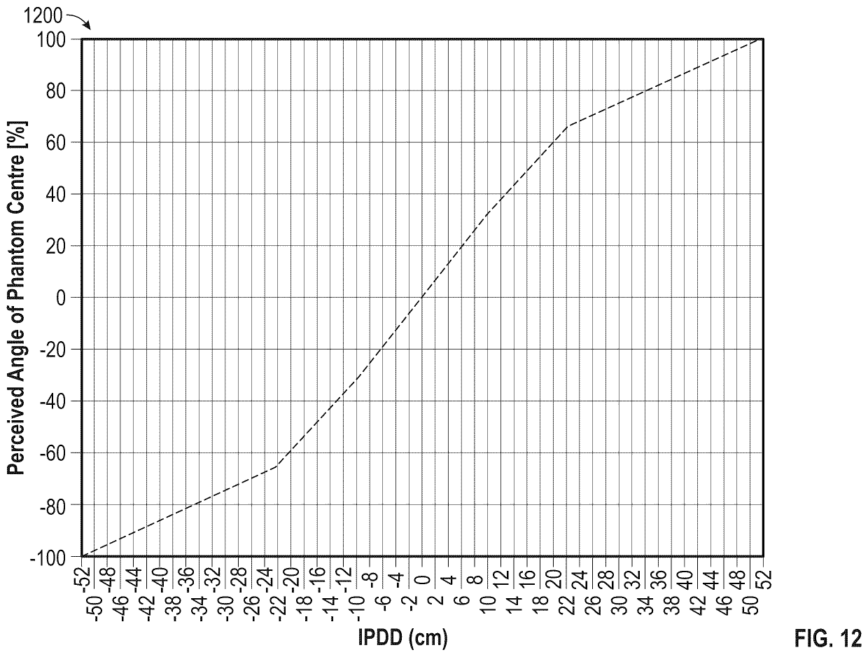

For a negative IPDD (i.e., IPDD_{PD}<0.0 m), where EE>IPDD_{PD}, then IPDD_{ED}<0. To address this situation, the perceptual data may be extended to the negative plane, such that y(x)=y(x) and y(−x)=−y(x). FIG. 12 depicts an example graph 1200 showing the perceived angle of phantom center shift based on IPDD extended to the negative plane according to one or more aspects.

In some aspects, the estimator error, EE, can be computed from measurements where a physical ground truth is available. For example, the estimator may be placed at a known distance from a loudspeaker, the estimator can then be used to estimate the distance from the loudspeaker, and the estimated distance can be compared with the known physical distance to determine the amount of estimator error. This can be repeated for many measurement positions, and repetitions, that are relevant to the intended application and environment. The known distance can, for example, be measured using ultra-accurate measurement tools such as a laser distance meter whose inherent error is magnitudes of order smaller than that of the estimator itself.

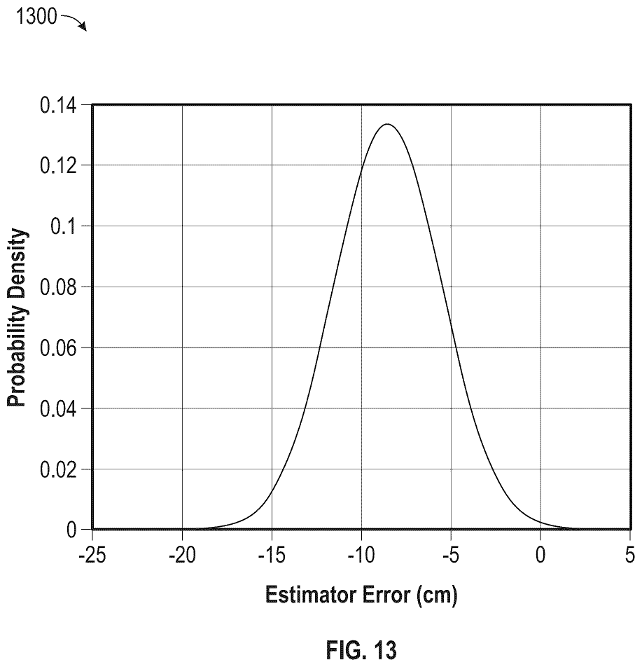

The estimator error will not take a single value, but rather a distribution. FIG. 13 depicts an example graph 1300 showing an example estimator error distribution according to one or more aspects. In the illustrated example, the mean estimator error is −8.5 cm, meaning that on average the estimator returns an estimated distance value that is 8.5 cm away from the physical ground truth, in a direction away from the true sweetspot. In the illustrated example, the standard deviation is 3 cm, meaning that 68% of all measurements returns an estimated distance value that is between −11.5 cm and −5.5 cm of error from the physical ground truth. In this example, if −8.5 cm is used as the estimator error, then the computed threshold will be valid for only 50% of the estimator error data because 50% of the data has less error than the mean. However, if the estimator error is selected at the smaller error standard distribution value, in this case EE=−5.5 cm, then a lower threshold will be determined, but is valid for only 16% of the estimator error data. If the estimator error is selected at the higher error standard distribution value, 84% of the data is represented. Thus, the selection of the estimator error value used to determine the threshold may depend on the particular error distribution data and design criteria for the adaptive sweetspot compensation.

While the Eq. 5 determined the error in the adaptive sweetspot compensation based on the IPDD_{PD}, the error in the adaptive sweetspot compensation may be based on the IPDD_{ED}. In practice, the loudspeaker-listener distance estimator provides IPDD_{ED} which is used by the adaptive sweetspot compensation system, whereas the IPDD_{PD} can be determined under fixed conditions (e.g., in a lab for data collection and test or during an initial calibration process), in deployment the loudspeaker-listener distances are estimated by the estimator technology. Using the IPDD_{ED}, the error in the adaptive sweetspot compensation can be determined as:

ε_{AdaptiveSweetspotCompensation}(IPDD_{ED})=y(IPDD_{ED})−y(IPDD_{ED}+EE) (eq. 6)

, where IPDD_{ED}+EE=IPDD_{PD}.

According to certain aspects, the threshold for enabling or disabling adaptive sweetspot compensation may be determined based on the perceptual data and the estimator error. The Eq. 6 provides the difference between the amount of sweetspot adaptation correction needed based on the ground truth error and the amount of sweetspot adaptation correction that would be applied based on the estimated error. To determine the threshold, ε_{AdaptiveSweetspotCompensation}(IPDD_{ED}) can be determined for the ground truth value y(IPDD_{ED})=0 as:

ε_{bypass}(IPDD_{ED})=0−y(IPDD_{ED}+EE) (eq. 7)

According to certain aspects, next, the determined ε_{bypass}(IPDD_{ED}) and ε_{AdaptiveSweetspotCompensation}(IPDD_{ED}) may be plotted to identify a point at which the error introduced by applying the adaptive sweetspot compensation ε_{AdaptiveSweetspotCompensation}(IPDD_{ED}) is less than the error that would be introduced by bypassing the adaptive sweetspot compensation ε_{bypass}(IPDD_{ED}) by setting the ground truth to zero.

In some aspects, the threshold and estimated amount of error detected are used to enable or disable adaptive sweetspot compensation. For example, if the amount of physical error is below the threshold, the adaptive sweetspot compensation may be disabled; and, if the amount of physical error is at or above the threshold, the adaptive sweetspot compensation may be enabled. The threshold can be used to ensure that adaptive sweetspot compensation is applied when the compensation will improve listener experience and is not applied when the compensation error, due to the estimator error, would introduce more error than the physical error.

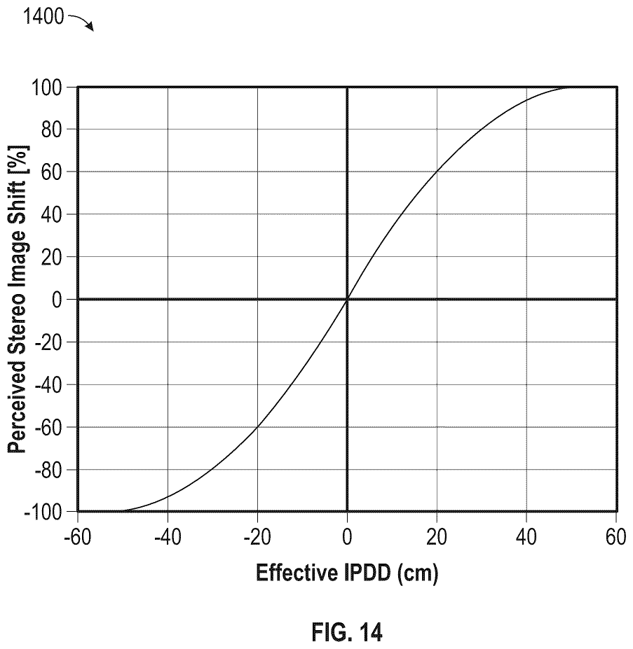

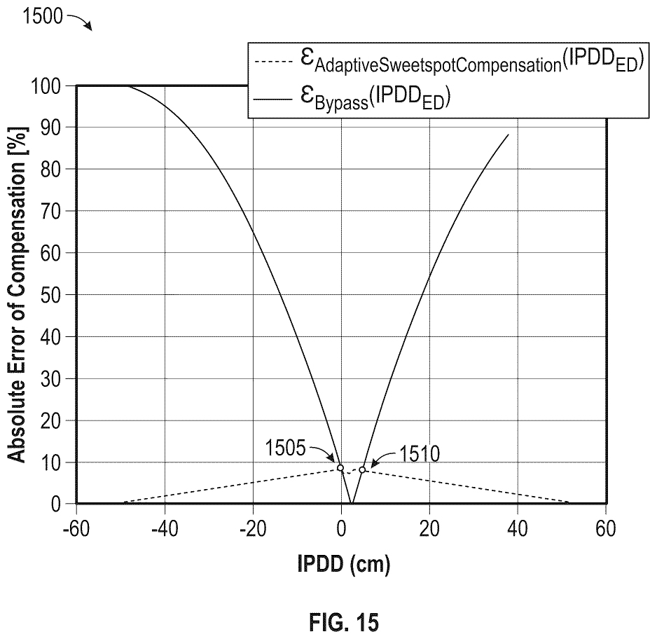

Referring back the example in the error distribution shown in FIG. 13 and selecting the standard deviation error of −11.5 cm, the example perceptual data extended to the negative plane shown in FIG. 12 may be fit to a curve, such as a third order polynomial as shown in the example graph 1400 in FIG. 14. The Eq. 6 and Eq. 7 may then be solved to determine the values for the ε_{bypass}(IPDD_{ED}) and ε_{AdaptiveSweetspotCompensation}(IPDD_{ED}). The magnitude (absolute values) for the ε_{bypass}(IPDD_{ED}) and ε_{AdaptiveSweetspotCompensation}(IPDD_{ED}) may then be plotted for values of the IPDD as shown in the graph 1500 depicted in FIG. 15. As shown in the example graph 1500 in FIG. 15, two thresholds 1505 and 1510 can be determined at which ε_{AdaptiveSweetspotCompensation}(IPDD_{ED}) drops below ε_{bypass}(IPDD_{ED}), at IPDD=−0.3 cm and IPDD=4.8 cm. The thresholds 1505 and 1510 define a range (between −0.3 cm to 4.8 cm) outside of which applying adaptive sweetspot compensation results in lower error than bypassing the adaptive sweetspot compensation and outside of which applying adaptive sweetspot compensation results in higher error than bypassing the adaptive sweetspot compensation. According to certain aspects, therefore, the adaptive sweetspot compensation is enabled when the IPDD is outside of the range defined by the identified thresholds and adaptive sweetspot compensation is disabled when the IPDD is within the range defined by the identified thresholds.

According to certain aspects, to fine tune the estimation error, the system may estimate an uncertainty of raw measurements by the estimator. With bayesian inference, the uncertainty may be expressed as a distribution of distance estimates given the raw measurement data and known experimental data associated with the accuracy of the estimator, where more or less weight is given to the raw measurement data based on an amount of the measurement data. The distribution may be used to express the IPDD_{ED} as a distribution. The IPDD_{ED} distribution may be evaluated with respect to perceptual thresholds to determine whether to enable or disable adaptive sweetspot compensation.

### Example Method for Threshold for Adaptive Sweetspot Compensation

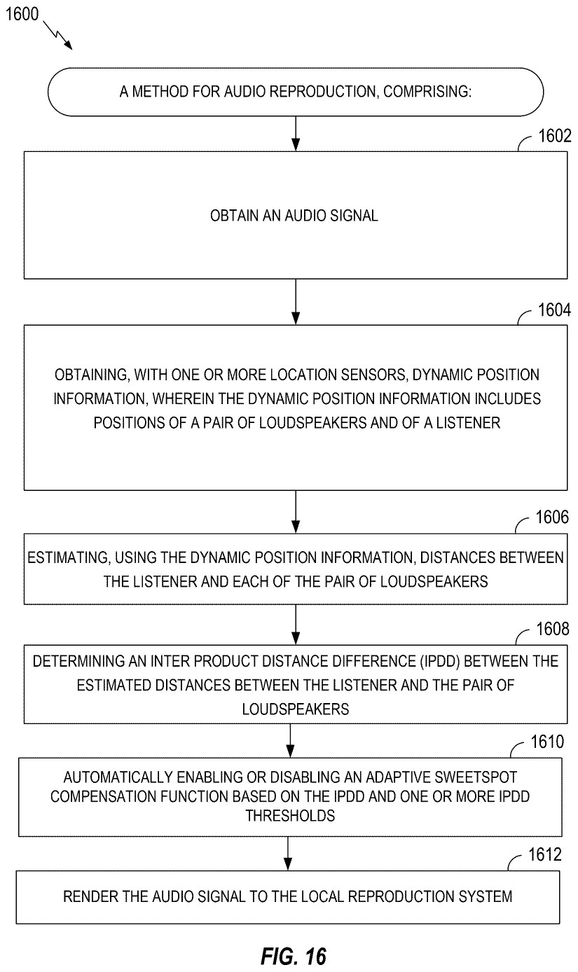

FIG. 16 is a flow diagram illustrating operations 1600 for audio reproduction, according to one or more aspects. The operations 1600 may be understood with reference to the FIGS. 1-15. The operations 1600 may be performed by an audio reproduction system (e.g., such as multimedia system 100). The controller may be located in a separate component within the audio reproduction system, may be located remotely (e.g., in a cloud), or may be integrated within another component of the audio reproduction system, such as a loudspeaker (e.g., such as loudspeaker 115 and/or 125).

Operations 1600 may begin, at operation 1602, with obtaining an audio signal. In some aspects, the audio signal is associated with one or more audio channels. In some aspects, each audio channel may be associated with a position of an audio source with respect to a reference point within a local reproduction system.

In some aspects, the operations 1600 further include, at operation 1604, obtaining, with one or more location sensors, dynamic position information. In some aspects, the dynamic position information includes positions of at least a pair of loudspeakers within the local reproduction system relative to the reference point, a position of a listener relative to the reference point, positions of the pair of loudspeakers relative to the listener, or a combination thereof;

In some aspects, the operations 1600 further include, at operation 1606, estimating, using the dynamic position information, distances between the listener and each of the pair of loudspeakers.

In some aspects, the operations 1600 further include, at operation 1608, determining an inter product distance difference (IPDD) between the estimated distances between the listener and the pair of loudspeakers.

In some aspects, the operations 1600 further include, at operation 1610, automatically enabling or disabling an adaptive sweetspot compensation function based on the IPDD and one or more IPDD thresholds.

In some aspects, the one or more IPDD thresholds includes two IPDD thresholds. In some aspects, automatically enabling or disabling the adaptive sweetspot compensation function based on the IPDD and the one or more IPDD thresholds at operation 1610 includes automatically enabling or disabling the adaptive sweetspot compensation function based on whether the IPDD is in a range between the two IPDD thresholds or the IPDD is outside of the range between the two IPDD thresholds.

In some aspects, automatically enabling or disabling the adaptive sweetspot compensation function at operation 1610 includes disabling the adaptive sweetspot compensation function in response to determining the IPDD is in the range between the two IPDD thresholds.

In some aspects, automatically enabling or disabling the adaptive sweetspot compensation function at operation 1610 includes enabling the adaptive sweetspot compensation function in response to determining the IPDD is outside the range between the two IPDD thresholds.

In some aspects, the operations 1600 further include, in response to enabling the adaptive sweetspot compensation function, applying one or more correction time delays and, optionally, one or more correction gains based on the dynamic position information. In some aspects, the one or more correction time delays and, optionally, the one or more correction gains are determined dynamically in response to enabling the adaptive sweetspot compensation function. In some aspects, the one or more correction time delays and, optionally, the one or more correction gains are recalled from memory in response to enabling the adaptive sweetspot compensation function. For example, the one or more correction gains and time delays may be previously determined and stored as presets.

In some aspects, the operations 1600 further include, at operation 1612, rendering the audio signal to the local reproduction system.

In some aspects, the operations 1600 further include determining the one or more IPDD thresholds.

In some aspects, determining the one or more IPDD thresholds includes determining an estimation error (EE) associated with the one or more location sensors and the estimating the distances between the listener and each of the pair of loudspeakers (e.g., as discussed with respect to the Eqs. 1-4 and FIGS. 8-14 above).

In some aspects, determining the one or more IPDD thresholds further comprises, for each of a plurality of IPDD values, estimating an error of enabling the adaptive sweetspot compensation function based on a function of the IPDD value and the estimator error (e.g., as discussed with respect to the Eq. 6 above). In some aspects, estimating the error of enabling the adaptive sweetspot compensation function comprises determining a difference of a first function of the IPDD value and a second function of a sum of the IPDD and the estimator error (e.g., as discussed with respect to the Eq. 6 above.

In some aspects, determining the one or more IPDD thresholds further comprises, for each of the plurality of IPDD values, estimating an error of disabling the adaptive sweetspot compensation function based on a function of the IPDD and the estimator error (e.g., as discussed with respect to the Eq. 7 above). In some aspects, estimating the error of disabling the adaptive sweetspot compensation function comprises determining a difference of zero and the second function of the sum of the IPDD value and the estimator error (e.g., as discussed with respect to the Eq. 6 above).

In some aspects, determining the one or more IPDD thresholds further comprises: for each of the plurality of IPDD values, comparing the error of enabling the adaptive sweetspot compensation function and the error of disabling the adaptive sweetspot compensation function (e.g., as discussed with respect to the FIG. 15 above); and identifying the two IPDD thresholds as an initial IPDD value and a last IPDD value of a range of IPDD values, of the plurality of IPDD values, in which the error of enabling the adaptive sweetspot compensation function is less than the error of disabling the adaptive sweetspot compensation function.

In some aspects, obtaining the dynamic position information, at 1604, comprises continuously collecting position data of the one or more loudspeakers, the listener, or both. In some aspects, obtaining the dynamic position information, at 1604, comprises, in response to a trigger, collecting position data of the one or more loudspeakers, the listener, or both. In some aspects, the dynamic position information comprises X-, Y-, and Z-Cartesian coordinates or Azimuth, elevation, and distance spherical coordinates. In some aspects, the trigger is a request from the listener. In some aspects, the trigger comprises detecting that a location of the listener has changed.

### Example System for Threshold for Dynamic Adaptive Sweetspot Compensation

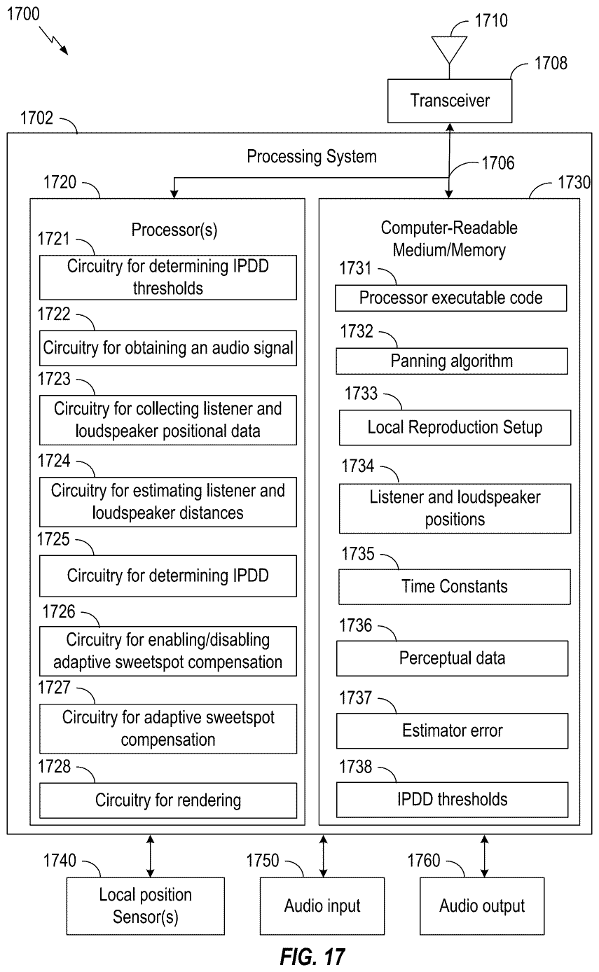

FIG. 17 depicts aspects of an example system 1700 for dynamic adaptive sweetspot compensation using thresholds. In some aspects, system 1700 is a controller. In some aspects, system 1700 is a loudspeaker, such as one of the loudspeakers 115, 120, 125, 130, and 135 described above with respect to FIG. 1. System 1700 may be implemented as a single devices or, in some aspects, components of system 1700 may be implemented across multiple physical devices within a multimedia system, such as multimedia system 100 described above with respect to FIG. 1, and/or within a network, such as by server 145 within network 140.

The system 1700 includes a processing system 1702 coupled to a transceiver 1708 (e.g., a transmitter and/or a receiver). The transceiver 1708 is configured to transmit and receive signals for the system 1700 via an antenna 1710, such as the various signals as described herein. The processing system 1702 may be configured to perform processing functions for the system 1700, including processing signals received and/or to be transmitted by the system 1700.

The processing system 1702 includes one or more processors 1720. The one or more processors 1720 are coupled to a computer-readable medium/memory 1730 via a bus 1706. In certain aspects, the computer-readable medium/memory 1730 is configured to store instructions (e.g., computer-executable code) that when executed by the one or more processors 1720, cause the one or more processors 1720 to perform the operations 1600 described with respect to FIG. 16, or any aspect related to it. Note that reference to a processor performing a function of system 1700 may include one or more processors performing that function of system 1700.

The one or more processors 1720 include circuitry configured to implement (e.g., execute) the aspects described herein for adaptive sound image width enhancement, including circuitry for determining IPDD thresholds 1721, circuitry for obtaining an audio signal 1722, circuitry for collecting listener and loudspeaker positional data 1723, circuitry for estimating listener and loudspeaker distances 1724, circuitry for determining IPDD 1725, circuitry for enabling/disabling adaptive sweetspot compensation 1726, circuitry for adaptive sweetspot compensation 1727, and circuitry for rendering 1728. Processing with circuitry 1721-1728 may cause the system 1700 to perform the operations 1600 described with respect to FIG. 16 or any aspect related to it.

In the depicted example, computer-readable medium/memory 1730 stores code (e.g., executable instructions). Processing of the code may cause the system 1700 to perform the operations 1600 described with respect to FIG. 16, or any aspect related to it. In addition, computer-readable medium/memory 1730 may store information that can be used by the processors 1720. For example, computer-readable medium/memory 1730 may store processor executable code 1731 that may be executable by the one or more processors 1720 to perform the operations 1600 described with respect to FIG. 16. The computer-readable medium/memory 1730 may store a panning algorithm 1732 that may be used by the circuitry for rendering 1728. The computer-readable medium/memory 1730 may store local reproduction setup information 1733, listener and loudspeaker positions 1734, and time constants 1735 that may be used by the circuitry for estimating listener and loudspeaker distances 1724. The computer-readable medium/memory 1730 may store perceptual data 1736 and estimator error information 1737 that may be used by the circuitry for determining IPDD thresholds 1721. The computer-readable medium/memory 1730 may store IPDD thresholds 1738 that may be used by the circuitry for enabling/disabling sweetspot compensation 1726.

In addition, the system 1700 may include local position sensor(s) 1740 configured to collect raw listener and loudspeaker position data provided to the circuitry for estimating the listener and loudspeaker distances 1724. The system 1700 may also include a wired audio input 1750 and a wired audio output 1760, for obtaining and outputting audio signals.

Therefore from one perspective, there have been described approaches for a method of audio reproduction including obtaining an audio signal. The method includes obtaining, with one or more location sensors, dynamic position information including position data of a listener and of at least a pair of loudspeakers within a local reproduction system. The method includes estimating distances between the listener and each of the pair of loudspeakers. The method includes determining an estimated inter product distance difference (IPDD) of the estimated distances between the listener and each of the pair of loudspeakers. The method includes automatically enabling or disabling an adaptive sweetspot compensation function based on the estimated IPDD and on one or more IPDD thresholds. The method includes rendering the audio signal to the local reproduction system.

### EXAMPLE ASPECTS

In addition to the various aspects described above, specific combinations of aspects are within the scope of the disclosure, some of which are detailed below:
Aspect 1: A method of audio reproduction, the method comprising: obtaining, with one or more location sensors, dynamic position information, wherein the dynamic position information includes position data of a listener and of a pair of loudspeakers within a local reproduction system; estimating, using the dynamic position information, distances between the listener and each of the pair of loudspeakers; determining an estimated inter product distance difference (IPDD) of the estimated distances between the listener and each of the pair of loudspeakers; automatically enabling or disabling an adaptive sweetspot compensation function based on the estimated IPDD and on one or more IPDD thresholds; obtaining an audio signal; and rendering the audio signal to the local reproduction system.
Aspect 2: The method of Aspect 1, wherein: the one or more IPDD thresholds comprise two IPDD thresholds; and automatically enabling or disabling the adaptive sweetspot compensation function based on the estimated IPDD and on the one or more IPDD thresholds comprises automatically enabling or disabling the adaptive sweetspot compensation function based on whether the estimated IPDD is in a range between the two IPDD thresholds or the estimated IPDD is outside of the range between the two IPDD thresholds.
Aspect 3: The method of Aspect 2, wherein the two IPDD thresholds comprises a first IPDD threshold that is a lower bound of the range and a second IPDD threshold that is an upper bound of the range, and wherein the first IPDD threshold is an IPPD value<0.0 meters and the second IPDD threshold is an IPDD value>0.0 meters.
Aspect 4: The method of any combination of Aspects 2-3, wherein automatically enabling or disabling the adaptive sweetspot compensation function comprises disabling the adaptive sweetspot compensation function in response to determining the estimated IPDD is within the range of the two IPDD thresholds.
Aspect 5: The method of any combination of Aspect 2-3, wherein automatically enabling or disabling the adaptive sweetspot compensation function comprises enabling the adaptive sweetspot compensation function in response to determining the estimated IPDD is outside the range of the two IPDD thresholds.
Aspect 6: The method of Aspect 5, further comprising, in response to enabling the adaptive sweetspot compensation function, applying one or more correction time delays and, optionally, one or more correction gains based on the dynamic position information.
Aspect 7: The method of Aspect 6, wherein the one or more correction time delays and optional one or more correction gains are dynamically determined in response to enabling the adaptive sweetspot compensation function or are recalled from a storage in response to enabling the adaptive sweetspot compensation function.
Aspect 8: The method of any combination of Aspects 1-7, further comprising determining the one or more IPDD thresholds.
Aspect 9: The method of Aspect 8, wherein determining the one or more IPDD thresholds comprises determining an estimation error (EE) associated with the one or more location sensors and the estimation of the distances between the listener and each of the pair of loudspeakers.
Aspect 10: The method of Aspect 9, wherein determining the one or more IPDD thresholds further comprises, for each of a plurality of IPDD values, estimating an error associated with enabling the adaptive sweetspot compensation function based on a function of the IPDD value and the estimator error.
Aspect 11: The method of Aspect 10, wherein the function is based on perceptual data.
Aspect 12: The method of Aspect 10, wherein estimating the error of enabling the adaptive sweetspot compensation function comprises determining a difference of a first function of the IPDD value and a second function of a sum of the IPDD and the estimator error.
Aspect 13: The method of any combination of Aspects 10-12, wherein determining the one or more IPDD thresholds further comprises, for each of the plurality of IPDD values, estimating an error associated with disabling the adaptive sweetspot compensation function based on a function of the IPDD and the estimator error.
Aspect 14: The method of Aspect 13, wherein estimating the error associated with disabling the adaptive sweetspot compensation function comprises determining a difference of zero and the second function of a sum of the IPDD value and the estimator error.
Aspect 15: The method of any combination of Aspects 13-14, wherein determining the one or more IPDD thresholds further comprises: for each of the plurality of IPDD values, comparing the error associated with enabling the adaptive sweetspot compensation function and the error associated with disabling the adaptive sweetspot compensation function; and identifying, from the plurality of IPDD values, a first IPDD threshold as a lower-bound IPDD value, of a range of IPDD values, and a second IPPD threshold as an upper-bound IPDD value of the range of IPDD values, wherein the range of IPDD values comprises IPDD values at which the error of enabling the adaptive sweetspot compensation function is greater than the error of disabling the adaptive sweetspot compensation function.
Aspect 16: The method of any combination of Aspects 1-15, wherein determining the dynamic position information comprises continuously, or in response to a trigger, collecting position data of the one or more loudspeakers, the listener, or both, and wherein the dynamic position information comprises X-, Y-, and Z-Cartesian coordinates or Azimuth, elevation, and distance spherical coordinates.
Aspect 17: The method of Aspect 16, wherein the trigger comprises a request from the listener or detecting that a location of the listener has changed.
Aspect 18: An apparatus comprising means for performing a method in accordance with any of Aspects 1-17.
Aspect 19: A computer-readable medium comprising executable instructions that, when executed by one or more processors of an apparatus, cause the apparatus to perform a method in accordance with any of Aspects 1-17.
Aspect 20: A computer program product embodied on a computer-readable storage medium comprising code for performing a method in accordance with any of Aspects 1-17.
Aspect 21: An apparatus comprising: a memory comprising executable instructions and one or more processors configured to execute the executable instructions and cause the apparatus to perform a method in accordance with any of Aspects 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The methods disclosed herein include providing instructions (e.g. software) to a programmable device (e.g. processor, ASIC or circuit) to cause the programmable device to become configured to carry out the methods. Such instructions may be provided to the programmable device using a computer-readable medium. A computer-readable medium may be provided as a computer-readable storage medium. Such a computer-readable storage medium may be referred to as a non-transitory computer-readable medium. Examples of a computer-readable storage medium may include a CD, a DVD, a storage device, a diskette, a tape, flash memory, physical memory, or any other computer-readable storage medium. A computer-readable medium may also or alternatively be provided as a transmission medium by which instructions may be conveyed. A computer-readable transmission medium may include carrier waves, transmission signals or the like. A computer-readable transmission medium may convey instructions between components of a single computer system and/or between plural separate computer systems.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of audio reproduction, the method comprising:
obtaining, with one or more location sensors, dynamic position information, wherein the dynamic position information includes position data of a listener and of a pair of loudspeakers within a local reproduction system;
estimating, using the dynamic position information, distances between the listener and each of the pair of loudspeakers;
determining an estimated inter product distance difference (IPDD) of the estimated distances between the listener and each of the pair of loudspeakers;
automatically enabling or disabling an adaptive sweetspot compensation function based on the estimated IPDD and on one or more IPDD thresholds;
obtaining an audio signal; and
rendering the audio signal to the local reproduction system.

2. The method of claim 1, wherein:
the one or more IPDD thresholds comprise two IPDD thresholds; and
automatically enabling or disabling the adaptive sweetspot compensation function based on the estimated IPDD and on the one or more IPDD thresholds comprises automatically enabling or disabling the adaptive sweetspot compensation function based on whether the estimated IPDD is in a range between the two IPDD thresholds or the estimated IPDD is outside of the range between the two IPDD thresholds.

3. The method of claim 2, wherein the two IPDD thresholds comprises a first IPDD threshold that is a lower bound of the range and a second IPDD threshold that is an upper bound of the range, and wherein the first IPDD threshold is an IPPD value<0.0 meters and the second IPDD threshold is an IPDD value>0.0 meters.

4. The method of claim 2, wherein automatically enabling or disabling the adaptive sweetspot compensation function comprises disabling the adaptive sweetspot compensation function in response to determining the estimated IPDD is within the range of the two IPDD thresholds.

5. The method of claim 2, wherein automatically enabling or disabling the adaptive sweetspot compensation function comprises enabling the adaptive sweetspot compensation function in response to determining the estimated IPDD is outside the range of the two IPDD thresholds.

6. The method of claim 5, further comprising, in response to enabling the adaptive sweetspot compensation function, applying one or more correction time delays and, optionally, one or more correction gains based on the dynamic position information, wherein the one or more correction time delays and optional one or more correction gains are dynamically determined in response to enabling the adaptive sweetspot compensation function or are recalled from a storage in response to enabling the adaptive sweetspot compensation function.

7. The method of claim 1, further comprising determining the one or more IPDD thresholds, wherein determining the one or more IPDD thresholds comprises:
determining an estimation error (EE) associated with the one or more location sensors and the estimation of the distances between the listener and each of the pair of loudspeakers; and
for each of a plurality of IPDD values, estimating an error associated with enabling the adaptive sweetspot compensation function based on a function of the IPDD value and the estimator error.

8. The method of claim 7, wherein the function is based on perceptual data.

9. The method of claim 7, wherein estimating the error of enabling the adaptive sweetspot compensation function comprises determining a difference of a first function of the IPDD value and a second function of a sum of the IPDD and the estimator error.

10. The method of claim 7, wherein determining the one or more IPDD thresholds further comprises, for each of the plurality of IPDD values, estimating an error associated with disabling the adaptive sweetspot compensation function based on a function of the IPDD and the estimator error.

11. The method of claim 10, wherein estimating the error associated with disabling the adaptive sweetspot compensation function comprises determining a difference of zero and the second function of a sum of the IPDD value and the estimator error.

12. The method of claim 10, wherein determining the one or more IPDD thresholds further comprises:
for each of the plurality of IPDD values, comparing the error associated with enabling the adaptive sweetspot compensation function and the error associated with disabling the adaptive sweetspot compensation function; and
identifying, from the plurality of IPDD values, a first IPDD threshold as a lower-bound IPDD value, of a range of IPDD values, and a second IPPD threshold as an upper-bound IPDD value of the range of IPDD values, wherein the range of IPDD values comprises IPDD values at which the error of enabling the adaptive sweetspot compensation function is greater than the error of disabling the adaptive sweetspot compensation function.

13. The method of claim 1, wherein obtaining the dynamic position information comprises continuously, or in response to a trigger, collecting position data of the one or more loudspeakers, the listener, or both, and wherein the dynamic position information comprises X-, Y-, and Z-Cartesian coordinates or Azimuth, elevation, and distance spherical coordinates.

14. The method of claim 13, wherein the trigger comprises a request from the listener or detecting that a location of the listener has changed.

15. A system for audio reproduction, the system comprising:
a local reproduction system including at least a pair of loudspeakers;
one or more location sensors configured to collect raw position data, wherein the raw position data includes position data of a listener and of the pair of loudspeakers;
one or more processors configured to:
determine dynamic position information from the raw position data;
estimate, using the dynamic position information, distances between the listener and each of the pair of loudspeakers;
determine an estimated inter product distance difference (IPDD) of the estimated distances between the listener and each of the pair of loudspeakers;
automatically enable or disable an adaptive sweetspot compensation function based on the estimated IPDD and on one or more IPDD thresholds; and
obtain an audio signal; and
a renderer configured to render the audio signal to the local reproduction system.
